(19) United States
(12) Patent Application Publication
(10) Pub. No.: US 2022/0101261 A1
(43) Pub. Date: Mar. 31, 2022

(54) METHOD AND APPARATUS FOR SECURE DELIVERY OF CARGO

(71) Applicant: Nokia Technologies Oy, Espoo (FI)

(72) Inventor: Fabian WIACEK, Warsaw (PL)

(21) Appl. No.: 17/421,553

(22) PCT Filed: Jan. 10, 2019
(86) PCT No.: PCT/FI2019/050014

§ 371 Date: Jul. 8, 2021

(51) Int. Cl. G06Q 10/08; G08G 5/00; B64C 39/02; G01C 21/34; G05D 1/00; G06Q 50/28

(52) U.S. Cl. CPC G06Q 10/08355; B64C 2201/14; B64C 39/024; G01C 21/343; G01C 21/3461; G05D 1/0027; G06Q 10/0832; G08G 5/0013; G08G 5/0026; G08G 5/0034; G08G 5/0039; G06Q 50/28; B64C 2201/042; B64C 2201/128; G08G 5/0069

(57) ABSTRACT

A system for secure delivery of cargo by vehicles, e.g. drones, includes a central controller (100) configured to generate a probability-based package or cargo routing plan including a sequence of forwarding addresses for delivery of cargo by drones, from a sender drone nest station to a destination drone nest station over an indirect route including drone flight corridors connecting drone nest stations (102A-102H) identified in the sequence of forwarding addresses. A drone nest station is configured to receive from the central controller, a forwarding address to a next drone nest station, the forwarding address associated with the cargo to be carried by a drone currently located at the drone nest station over a drone flight corridor connecting the drone nest station with the next drone nest station. Potential hijackers are deceived or confused by the indirect route traveled by the drones from the sender drone nest station to the destination drone nest station.

### FIELD

The field of the invention relates to enhancing security in transporting cargo, packages or other goods by vehicles.

### BACKGROUND

Vehicles, such as an autonomous, unmanned aerial vehicle (UAV) or drone, may be programmed to use radio-navigation or global positioning system (GPS) coordinates to guide it to an intended destination for delivery of cargo or packages. Vehicles can be provided for example by, but not limited to, aircrafts (e.g. UAVs or drones), cars and the like. UAVs are given herein as a more detailed but non-limiting example of vehicles that can deliver packages. If the cargo or packages are valuable, and this information is known to potential hijackers, they may try to intercept the drone, for example by radio frequency hacking to redirect the drone's flight route or otherwise interfere with the flight route to capture the drone. This may also include usage of physical force, e.g. drone shutting down due to the fragile nature of drones that may be vulnerable to physical forms of attack.

What is needed is a way to deceive or confuse potential hijackers to thwart attempts to intercept or interfere with the drone's flight route and capture the drone.

### SUMMARY

In accordance with an example embodiment of the invention, a system for secure delivery of cargo by drones includes a central controller of a plurality of drone nest stations distributed over a geographical area with drones operated on specified drone corridors. The central controller is configured to generate a probability-based drone routing plan that includes a sequence of forwarding addresses for delivery of cargo by drones, from a sender drone nest station to a destination drone nest station over an indirect route. Package or cargo delivery data (address, coordinates, package ID), may be provided on package standardized box envelope. The indirect route includes drone flight corridors connecting drone nest stations identified in the sequence of forwarding addresses. The probability that a drone departing from a drone nest station will travel along a particular one of N corridors that are departing from the station, is 1/N. The probability that a drone will travel along the concatenated sequence of corridors in the indirect route is the product of the probabilities for each component corridor in the overall route. The central controller uses corridor probabilities to generate each sequence of forwarding addresses for each of the indirect routes.

The probability-based drone routing plan received from central controller may be altered by each distributed local drone nest drone logic to reflect a current state of the drone nest network. The sequence of forwarding addresses for delivery of cargo by drones, from a sender drone nest station to a destination drone nest station over an indirect route, may be altered by each distributed local drone nest drone logic to reflect a current state of the drone nest network.

In accordance with an example embodiment of the invention, each drone nest station is configured to receive from the central controller, a forwarding address to a next drone nest station to which a departing drone is to travel. The forwarding address is associated with the cargo to be carried by a drone currently located at the drone nest station, over a drone flight corridor connecting to the next drone nest station. Potential hijackers will be deceived or confused by the indirect route traveled by the drones from the sender drone nest station to the destination drone nest station, since drone visual observation or drone tracking by a drone identifier, or any other tracking method, will not be sufficient to determine if a package or cargo is carried by this particular drone.

The Station

In accordance with an example embodiment of the invention, method for delivery of cargo, comprising:

receiving, by a station of one or more stations distributed over a geographical area, from one or more controllers of the one or more stations, at least one forwarding address from one or more forwarding addresses to one or more stations of the one or more stations, the at least one forwarding address associated with cargo carried by an arriving vehicle over an arrival vehicle route, the at least one forwarding address for instructing a departing vehicle located at the station to travel to a next station of the one or more stations, the at least one forwarding address having been provided by the one or more controllers from the one or more forwarding addresses in a probability-based package or cargo routing plan, from a sender station of the one or more stations to a destination station of the one or more stations over a route including the one or more stations identified in the one or more forwarding addresses; and

launching, by the station, the cargo carried by the departing vehicle to travel to the next station over a departing vehicle route, using the received at least one forwarding address.

In accordance with an example embodiment of the invention, further comprising:

determining, by the station, whether conditions have changed for traveling from the station to the next station; and

modifying, by the station, the received at least one forwarding address into a second forwarding address of another station of the one or more stations, if conditions are determined to have changed for traveling from the station to the next station.

In accordance with an example embodiment of the invention, wherein the route including the one or more stations identified in the one or more forwarding addresses is an indirect route that provides a level of security for delivery of the package or cargo from the sender station of the one or more stations to the destination station of the one or more stations.

In accordance with an example embodiment of the invention, wherein the departing vehicle located at the station is different from the arriving vehicle.

In accordance with an example embodiment of the invention, wherein the cargo is one or more packages carried by each of a plurality of vehicles in different respective segments of the route.

In accordance with an example embodiment of the invention, wherein the vehicle includes a cargo compartment to provide additional protection against unauthorized access to the cargo and the cargo can wait for transportation over a next segment of the indirect route, and wherein the cargo is dropped by the vehicle on arrival at the station and the cargo is reloaded onto another vehicle that carries the cargo to the next station.

In accordance with an example embodiment of the invention, wherein the probability-based package or cargo routing plan includes at least one of user requirements for specified levels of security, with higher levels of security being provided by additional route segments of the indirect route, the probability-based package or cargo routing plan includes user requirements for specified “just in-time” delivery, specifying when a package is to be delivered to the destination station, the probability-based package or cargo routing plan includes fake vehicle delivery, or the probability-based package or cargo routing plan includes purposeful delays of delivered cargo or packages inside stations.

In accordance with an example embodiment of the invention, apparatus for delivery of cargo, comprising:

at least one processor;

at least one memory including computer program code;

the at least one memory and the computer program code configured to, with the at least one processor, cause the apparatus at least to:

receive, by a station of one or more stations distributed over a geographical area, from one or more controllers of the one or more stations, at least one forwarding address from one or more forwarding addresses to one or more stations of the one or more stations, the at least one forwarding address associated with cargo carried by an arriving vehicle over an arrival vehicle route, the at least one forwarding address for instructing a departing vehicle located at the station to travel to a next station of the one or more stations, the at least one forwarding address having been provided by the one or more controllers from the one or more forwarding addresses in a probability-based package or cargo routing plan, from a sender station of the one or more stations to a destination station of the one or more stations over a route including the one or more stations identified in the one or more forwarding addresses; and

cause launching, by the station, the cargo carried by the departing vehicle to travel to the next station over a departing vehicle route, using the received at least one forwarding address.

In accordance with an example embodiment of the invention, further comprising:

the at least one memory and the computer program code configured to, with the at least one processor, cause the apparatus at least to:

determine, by the station, whether conditions have changed for traveling from the station to the next station; and

modify, by the station, the received at least one forwarding address into a second forwarding address of another station of the one or more stations, if conditions are determined to have changed for traveling from the station to the next station.

In accordance with an example embodiment of the invention, computer program product comprising computer executable program code recorded on a computer readable non-transitory storage medium, the computer executable program code comprising:

code for receiving, by a station of one or more stations distributed over a geographical area, from one or more controllers of the one or more stations, at least one forwarding address from one or more forwarding addresses to one or more stations of the one or more stations, the at least one forwarding address associated with cargo carried by an arriving vehicle over an arrival vehicle route, the at least one forwarding address for instructing a departing vehicle located at the station to travel to a next station of the one or more stations, the at least one forwarding address having been provided by the one or more controllers from the one or more forwarding addresses in a probability-based package or cargo routing plan, from a sender station of the one or more stations to a destination station of the one or more stations over a route including the one or more stations identified in the one or more forwarding addresses; and code for launching, by the station, the cargo carried by the departing vehicle to travel to the next station over a departing vehicle route, using the received at least one forwarding address.

In accordance with an example embodiment of the invention, package or cargo delivery data (address, coordinates, package ID) and also other data (Sender name, Recipient name, contact details. etc.) may be provided on a standardized box or envelope. Standardized means, primarily, that boxes or envelopes are substantially similar looking, so that the content of the package cannot be recognized.

In accordance with an example embodiment of the invention, delivery data may be scanned by drone nest logic when package is ordered to be send. Based on this data a starting point and delivery point may be determined, and the first, second and others addresses may be determined by central controller or in distributed mode.

In accordance with an example embodiment of the invention, for drone nest network, package ID may be sufficient to identify where a package should be delivered. Other data may be inputted to the system when package is sending, or when a Sender requests such service. In such case, drone may arrive to indicated by Sender location and pick up the given package identified by attached package ID.

In accordance with an example embodiment of the invention, for final delivery of package or cargo, on the last flight, based on package ID and associated data within the system logic, or based on data provided directly on package standardized box envelope (see FIG. 7), the last drone nest station may identify where and when a package should be delivered.

The Controller

In accordance with an example embodiment of the invention, method for delivery of cargo, comprising:

generating, by a controller of one or more stations distributed over a geographical area, a probability-based package or cargo routing plan including one or more forwarding addresses to one or more stations of the one or more stations, for delivery of cargo from a sender station of the one or more stations to a destination station of the one of more stations over a route including the one or more stations identified in the one or more forwarding addresses; and

transmitting, by the controller, to a station of the one or more stations, at least one forwarding address from the one or more forwarding addresses, the at least one forwarding address associated with cargo carried by an arriving vehicle at the station over an arrival vehicle route, the at least one forwarding address for instructing a departing vehicle located at the station to travel to a next station of the one or more stations.

In accordance with an example embodiment of the invention, wherein the route including the one or more stations identified in the one or more forwarding addresses is an indirect route that provides a level of security for delivery of the package or cargo from the sender station of the one or more stations to the destination station of the one or more stations.

In accordance with an example embodiment of the invention, further comprising:

generating, by the controller, a first probability-based package or cargo routing plan for a first level of security, the first plan including a first sequence of planned forwarding addresses for delivery of cargo to a first sequence of the one or more stations from the sender station to the destination station;

generating, by the controller, a first forecast blockchain record for each of the one or more stations in the first sequence, each first forecast blockchain record contents including at least a planned next forwarding address of a next station in the first sequence of the one or more stations and information related to alternate next stations of the one or more stations, the controller computing a cryptographic hash value on a combination of a previous forecast blockchain record computed for a previous station of the one or more stations in the first sequence and the contents of the first forecast blockchain record;

generating, by the controller, a second probability-based package or cargo routing plan for a second level of security, the second plan including a second sequence of planned forwarding addresses for delivery of cargo to a second sequence of the one or more stations from the sender station to the destination station;

generating, by the controller, a second forecast blockchain record for each of the one or more stations in the second sequence, each second forecast blockchain record contents including at least a planned next forwarding address of a next station in the second sequence of the one or more stations and information related to alternate next stations of the one or more stations, the controller computing a cryptographic hash value on a combination of a previous forecast blockchain record computed for a previous station of the one or more stations in the second sequence and the contents of the second forecast blockchain record; and

selecting, by the controller, either the first probability-based package or cargo routing plan for the first level of security or the second probability-based package or cargo routing plan for the second level of security, based on a required level of security for delivery of the package or cargo.

In accordance with an example embodiment of the invention, wherein the first plan including the first sequence of planned forwarding addresses is over a first indirect route from the sender station to the destination station having the first level of security and the second plan including the second sequence of planned forwarding addresses is over a second indirect route from the sender station to the destination station having the second level of security.

In accordance with an example embodiment of the invention, wherein vehicles are autonomous, unmanned aerial vehicles (UAV) or drones.

In accordance with an example embodiment of the invention, apparatus for delivery of cargo, comprising:

at least one processor;

at least one memory including computer program code;

the at least one memory and the computer program code configured to, with the at least one processor, cause the apparatus at least to:

generate, by a controller of one or more stations distributed over a geographical area, a probability-based package or cargo routing plan including one or more forwarding addresses to one or more stations of the one or more stations, for delivery of cargo from a sender station of the one or more stations to a destination station of the one of more stations over a route including the one or more stations identified in the one or more forwarding addresses; and

transmit, by the controller, to a station of the one or more stations, at least one forwarding address from the one or more forwarding addresses, the at least one forwarding address associated with cargo carried by an arriving vehicle at the station over an arrival vehicle route, the at least one forwarding address for instructing a departing vehicle located at the station to travel to a next station of the one or more stations.

In accordance with an example embodiment of the invention, wherein the route including the one or more stations identified in the one or more forwarding addresses is an indirect route that provides a level of security for delivery of the package or cargo from the sender station of the one or more stations to the destination station of the one or more stations.

In accordance with an example embodiment of the invention, further comprising:

the at least one memory and the computer program code configured to, with the at least one processor, cause the apparatus at least to:

generate, by the controller, a first probability-based package or cargo routing plan for a first level of security, the first plan including a first sequence of planned forwarding addresses for delivery of cargo to a first sequence of the one or more stations from the sender station to the destination station;

generate, by the controller, a first forecast blockchain record for each of the one or more stations in the first sequence, each first forecast blockchain record contents including at least a planned next forwarding address of a next station in the first sequence of the one or more stations and information related to alternate next stations of the one or more stations, the controller computing a cryptographic hash value on a combination of a previous forecast blockchain record computed for a previous station of the one or more stations in the first sequence and the contents of the first forecast blockchain record;

generate, by the controller, a second probability-based package or cargo routing plan for a second level of security, the second plan including a second sequence of planned forwarding addresses for delivery of cargo to a second sequence of the one or more stations from the sender station to the destination station;

generate, by the controller, a second forecast blockchain record for each of the one or more stations in the second sequence, each second forecast blockchain record contents including at least a planned next forwarding address of a next station in the second sequence of the one or more stations and information related to alternate next stations of the one or more stations, the controller computing a cryptographic hash value on a combination of a previous forecast blockchain record computed for a previous station of the one or more stations in the second sequence and the contents of the second forecast blockchain record; and

select, by the controller, either the first probability-based package or cargo routing plan for the first level of security or the second probability-based package or cargo routing plan for the second level of security, based on a required level of security for delivery of the package or cargo.

In accordance with an example embodiment of the invention, computer program product comprising computer executable program code recorded on a computer readable non-transitory storage medium, the computer executable program code comprising:

code for generating, by a controller of one or more stations distributed over a geographical area, a probability-based package or cargo routing plan including one or more forwarding addresses to one or more stations of the one or more stations, for delivery of cargo from a sender station of the one or more stations to a destination station of the one of more stations over a route including the one or more stations identified in the one or more forwarding addresses; and

code for transmitting, by the controller, to a station of the one or more stations, at least one forwarding address from the one or more forwarding addresses, the at least one forwarding address associated with cargo carried by an arriving vehicle at the station over an arrival vehicle route, the at least one forwarding address for instructing a departing vehicle located at the station to travel to a next station of the one or more stations.

In accordance with an example embodiment of the invention, further comprising:

code for generating, by the controller, a first probability-based package or cargo routing plan for a first level of security, the first plan including a first sequence of planned forwarding addresses for delivery of cargo to a first sequence of the one or more stations from the sender station to the destination station;

code for generating, by the controller, a first forecast blockchain record for each of the one or more stations in the first sequence, each first forecast blockchain record contents including at least a planned next forwarding address of a next station in the first sequence of the one or more stations and information related to alternate next stations of the one or more stations, the controller computing a cryptographic hash value on a combination of a previous forecast blockchain record computed for a previous station of the one or more stations in the first sequence and the contents of the first forecast blockchain record;

code for generating, by the controller, a second probability-based package or cargo routing plan for a second level of security, the second plan including a second sequence of planned forwarding addresses for delivery of cargo to a second sequence of the one or more stations from the sender station to the destination station;

code for generating, by the controller, a second forecast blockchain record for each of the one or more stations in the second sequence, each second forecast blockchain record contents including at least a planned next forwarding address of a next station in the second sequence of the one or more stations and information related to alternate next stations of the one or more stations, the controller computing a cryptographic hash value on a combination of a previous forecast blockchain record computed for a previous station of the one or more stations in the second sequence and the contents of the second forecast blockchain record; and

code for selecting, by the controller, either the first probability-based package or cargo routing plan for the first level of security or the second probability-based package or cargo routing plan for the second level of security, based on a required level of security for delivery of the package or cargo.

Additional Apparatus

In accordance with an example embodiment of the invention, apparatus for secure delivery of package or cargo, comprising:

at least one processor;

at least one memory including computer program code;

the at least one memory and the computer program code configured to, with the at least one processor, cause the apparatus at least to:

plan routes between different destinations and stations for secure package or cargo delivery, including alternative subroutes between the stations;

measure probabilities for traversing the different routes and alternative subroutes between the different stations for secure delivery of package or cargo, and

select one or more of the different routes or alternative subroutes whose measured probability provides a required level of security for delivery of package or cargo.

In accordance with an example embodiment of the invention, further comprising:

the at least one memory and the computer program code configured to, with the at least one processor, cause the apparatus at least to:

select one or more alternative vehicles for delivery of package or cargo to be used in the one or more selected different routes or alternative subroutes.

In accordance with an example embodiment of the invention, further comprising:

the at least one memory and the computer program code configured to, with the at least one processor, cause the apparatus at least to:

determine availability of one or more vehicles one or more of the different routes or alternative subroutes for delivery of package or cargo.

Blockchain Generation in the Controller

In accordance with an example embodiment of the invention, method for planning secure delivery of package or cargo, comprising:

generating, by a controller of a plurality of stations distributed over a geographical area, a first probability-based package or cargo routing plan for a first level of security, the first plan including a first sequence of planned forwarding addresses for delivery of cargo to a first sequence of stations, from a sender station of the plurality of stations to a destination station of the plurality of stations over an indirect route including corridors connecting the plurality of stations identified in the sequence of forwarding addresses;

generating, by the controller, a first forecast blockchain record for each of the plurality of stations in the first sequence from the sender station to the destination station, each first forecast blockchain record contents including at least a planned next forwarding address of a next station in the first sequence of planned forwarding addresses and information related to alternate next stations, the controller computing a cryptographic hash value on a combination of a previous forecast blockchain record computed for a next previous station in the sequence and the contents of the first forecast blockchain record;

generating, by the controller of the plurality of stations distributed over the geographical area, a second probability-based package or cargo routing plan for a second level of security, the second plan including a second sequence of planned forwarding addresses for delivery of cargo to second sequence of stations, from a sender station of the plurality of stations to a destination station of the plurality of stations over an indirect route including corridors connecting the plurality of stations identified in the sequence of forwarding addresses;

generating, by the controller, a second forecast blockchain record for each of the plurality of stations in the second sequence from the sender station to the destination station, each second forecast blockchain record contents including at least a planned next forwarding address of a next station in the second sequence of planned forwarding addresses and information related to alternate next stations, the controller computing a cryptographic hash value on a combination of a previous forecast blockchain record computed for a next previous station in the sequence and the contents of the second forecast blockchain record; and

selecting, by the controller, either the first probability-based package or cargo routing plan for the first level of security or the second probability-based package or cargo routing plan for the second level of security, based on a required level of security for delivery of the package or cargo.

In accordance with an example embodiment of the invention, wherein the cargo is carried by drones traveling in drone flight corridors connecting the stations, from the sender station of the plurality of stations to the destination station of the plurality of stations over the indirect route including the drone flight corridors.

### DESCRIPTION OF THE FIGURES

FIG. 1 illustrates an example network diagram of a Drone Nest Network including a plurality of drone nest stations distributed over a geographical area and a central controller, in accordance with an example embodiment of the invention.

FIG. 2A illustrates an example network diagram of the Drone Nest Network of FIG. 1, illustrating the central controller generating a probability-based cargo or package routing plan including a sequence of forwarding addresses for delivery of cargo by drones, from a sender drone nest station A to a destination drone nest station C over an indirect route including drone flight corridors connecting drone nest stations identified in the sequence of forwarding addresses from the same sender station to the same destination station, in accordance with an example embodiment of the invention.

FIG. 2B illustrates an example network diagram of the Drone Nest Network of FIG. 1, illustrating the central controller generating a second probability-based package or cargo routing plan for the same sender drone nest station A to the same destination drone nest station C, in accordance with an example embodiment of the invention.

FIG. 2C illustrates an example network diagram of the Drone Nest Network of FIG. 1, illustrating the central controller generating a third probability-based package or cargo routing plan for the same sender drone nest station A to the same destination drone nest station C, in accordance with an example embodiment of the invention.

FIG. 2D illustrates an example network diagram of the Drone Nest Network of FIG. 1, illustrating the central controller generating a different probability-based package or cargo routing plan for a different sender drone nest station D to a different destination drone nest station F, in accordance with an example embodiment of the invention.

FIG. 3 illustrates an example network diagram of the Drone Nest Network of FIG. 1, illustrating a snapshot in time of the central controller generating two different probability-based package or cargo routing plans for two different sender drone nest stations A and D to two different destination drone nest stations C and F, in accordance with an example embodiment of the invention.

FIG. 3A illustrates an example network diagram of the Drone Nest Network of FIG. 1, illustrating handling cargo capacity in the distributed method of drone-based package delivery system, in accordance with an example embodiment of the invention.

FIG. 3B illustrates an example network diagram of the Drone Nest Network of FIG. 1, illustrating just-in-time delivery in the distributed method of drone-based package delivery system, in accordance with an example embodiment of the invention.

FIG. 4 illustrates an example computing device, which may be a component of, for example, the one or more of the drone nest stations or the central controller of FIG. 1.

FIG. 4A illustrates an example of blockchain generation by the central controller, to generate a current blockchain record of the previous path of stations traversed by the cargo from the sender station to the current station, in accordance with an example embodiment of the invention.

FIG. 4B illustrates an example of blockchain generation by the central controller, to generate forecast blockchain records planning for cargo delivery in the drone nest network.

FIG. 5 illustrates an example of a drone nest package management unit, in accordance with an example embodiment of the invention.

FIG. 6 illustrates an example of drone corridors between adjacent drone nest stations, in accordance with an example embodiment of the invention.

FIG. 7 illustrates an example of a standardized package box (A), double-sized standardized package box (B) and drone cargo compartment attached to the drone for 3 packages, recipient data (an address, GPS coordinates) may be provided on package box envelope, in accordance with an example embodiment of the invention.

FIG. 8 illustrates an example of a drone nest for 4 units, in accordance with an example embodiment of the invention.

FIG. 9 illustrates an example of high availability of drone service, in accordance with an example embodiment of the invention.

FIG. 10A illustrates an example flow diagram of operational steps in a drone nest station for the secure delivery of cargo by drones, in accordance with an example embodiment of the invention.

FIG. 10B illustrates an example flow diagram 1050 of operational steps in the central controller for the secure delivery of cargo by drones, in accordance with an example embodiment of the invention.

FIG. 11 illustrates an example embodiment of the invention, wherein examples of removable storage media are shown, in accordance with an example embodiment of the invention.

### DISCUSSION OF EXAMPLE EMBODIMENTS OF THE INVENTION

In an example embodiment of the invention, a system for secure delivery of cargo by vehicles, such as drones for example, includes a central controller configured to generate a probability-based package or cargo routing plan including a sequence of forwarding addresses for delivery of cargo by drones, from a sender drone nest station to a destination drone nest station over an indirect route including drone flight corridors connecting drone nest stations identified in the sequence of forwarding addresses. A drone nest station is configured to receive from the central controller, a forwarding address to a next drone nest station, the forwarding address associated with the cargo to be carried by a drone currently located at the drone nest station over a drone flight corridor connecting the drone nest station with the next drone nest station. Potential hijackers are deceived or confused by the indirect route flown by potentially different drones from the sender drone nest station to the destination drone nest station. The drone delivery system may be one part of delivery system which may include e.g. cars, ships.

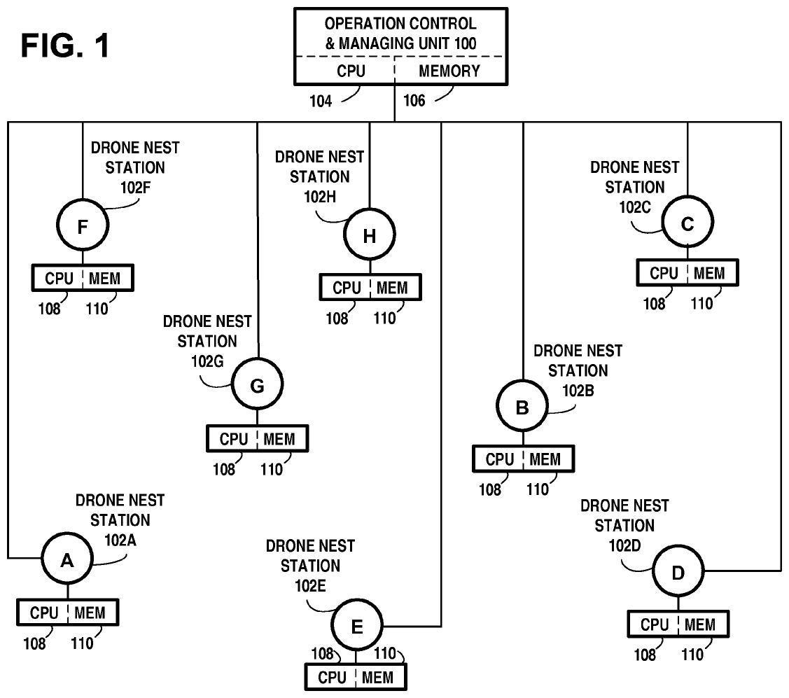

FIG. 1 illustrates an example network diagram of a Drone Nest Network including a plurality of eight drone nest stations 102 distributed over a geographical area and a central controller 100. The central, operation control and managing unit or controller 100 includes a central processing unit (CPU) 104 and a memory (MEM) 106 that stores computer code instructions, which when executed by the CPU 104, carry out the functions of the example embodiments of the invention. The central controller 100 stores the geographic coordinates of the drone nest stations 102A to 102H, including the locations of drone flight corridors connecting the drone nest stations. The central controller 100 communicates with the drone nest stations 102A to 102H over a communications network that may be a wireless network, a wired network, or a combination of both types of networks. Each of the drone nest stations 102A to 102H includes a central processing unit (CPU) 108 and a memory (MEM) 110 that stores computer code instructions, which when executed by the CPU 108, carry out the functions of the example embodiments of the invention. Each of the drone nest stations 102A to 102H provides a platform for receiving an arriving autonomous, unmanned aerial vehicle (UAV) or drone, electrically recharging drones, securely storing drones, securely storing a cargo/packages not attached to drones, and launching drones to travel to another one of the drone nest stations 102A to 102H.

In an example embodiment of the invention, a ground control station (GCS) application e.g. in one or more of the drone nest stations 102A to 102H or centrally in the cloud can be used to control drones over a Long-Term Evolution (LTE) network or any other cellular network, new radio (NR, 5G) for example. Both the drone and the GCS may have radio modem to control the drones. A drone may have an onboard computer associated with autopilot for example.

Relevant UEs are a drone nest station and the drones themselves connected to a base station. An LTE modem with a registered SIM is required to enable a drone nest station or a drone to connect to an LTE network. The modems can often be connected to antennas for improved range.

The E-UTRAN, as the name implies, forms the access network, which comprises of multiple evolved base stations called eNodeB (eNB) or (e/g) NodeB. These base stations serve one or more cells, which the drone nest station and the drone can connect to. The main task of the eNB is to handle the communications between the drone nest station, the drone, and the Evolved Packet Core (EPC). In addition to being connected to the drone nest station, the drone, and the EPC, each eNB is also connected to its nearby peers for the purpose of signaling and handover packet forwarding. Each drone nest station and drone can belong to one cell and communicate with one eNB at a time, and a handover must be performed whenever the drone moves to a new cell.

The EPC forms the core network and it contains the Home Subscriber Server (HSS), the Packet Data Network Gateway (PGW), the Serving Gateway (SGW) and the Mobility Management Entity (MME). The HSS is a central database for information related to users and subscriptions. It is queried by the MME, which is responsible for control plane operations and drone nest station and drone authentication. Each drone nest station and drone is assigned their own serving gateway (SGW), which handles the routing, forwarding and buffering of packets. Packet gateway (PGW) on the other hand handles IP address allocation for drone nest station and drone and does all IP packet operations required for the connections towards the Packet Data Network (PDN).

One of the advantages of the cellular technology like LTE or 5G is the capability to use spatial multiplexing with Multiple Input Multiple Output (MIMO) technique. This means that both the sender and receiver use multiple antennas simultaneously to transfer multiple data streams, increasing the bandwidth of the link and latency is decreased, and yet more in 5G.

5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

Drones are traditionally controlled through a direct radio link, where both the drone itself and the drone nest station are equipped with radio transceivers and antennas. In this case, the vehicle must stay within range of the drone nest station and within line of sight, or risk losing the connection. On the other hand, if an existing LTE network is used, then the vehicle can freely move wherever there is network coverage. This also means that the control software may be physically in a different location.

Teleoperation refers to the traditional low-level control method where the drone is controlled with a radio controller or joysticks that allow maneuvering. An alternative real-time control method is guided waypoints or corridors. With this method, instead of controlling the drone directly, the user specifies a location to which the drone will directly attempt to move to. Typically, this is implemented as a map application on a drone nest station application, where the user may click to set the current target waypoint and destination for a drone.

Autonomous control can be considered a more sophisticated control method, which differs from direct teleoperation by having an UAV capable of performing operations even when communications are lost for a period of time. In its simplest form, autonomous control can be implemented as a list of mission or corridor items, which the UAV will carry out in sequence.

During flight, the UAV may send a continuous stream of telemetry reports back to the drone nest station. These reports contain information about the location and status of the UAV, as well as acknowledgements for commands and updates for current mission status as well battery charge and error status, for example. During flight, the UAV may send continuous data streams related to other possible services provided by drones such as surveillance, monitoring, measurements or inspections.

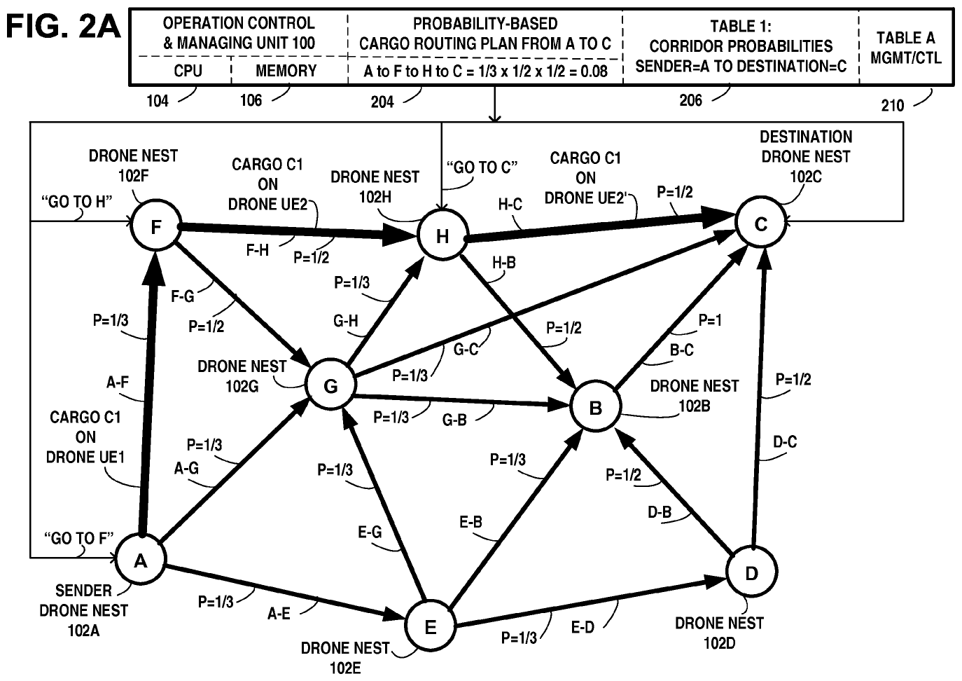

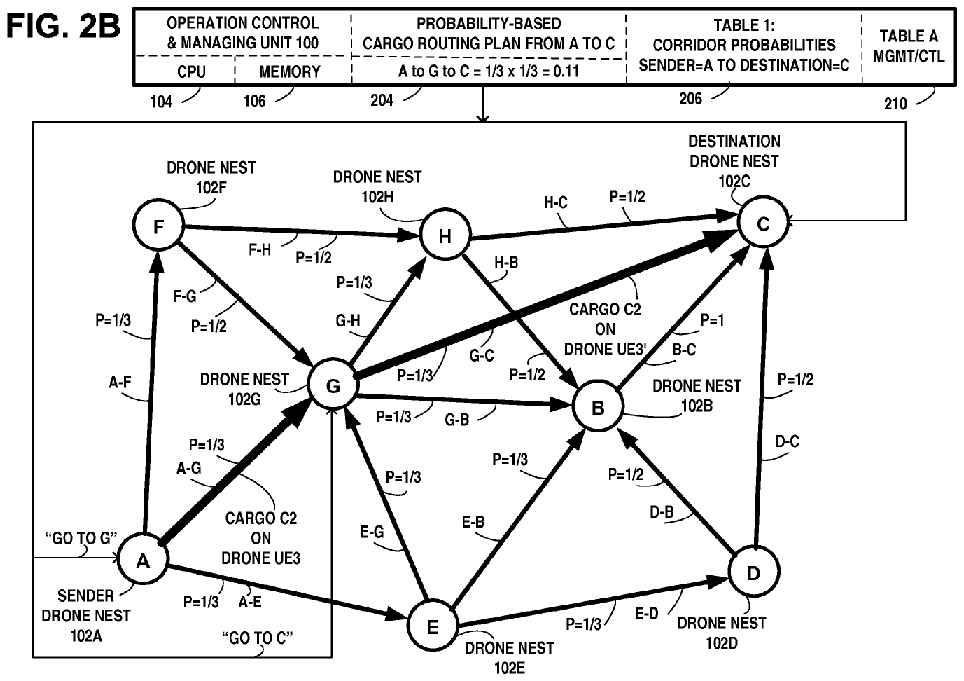

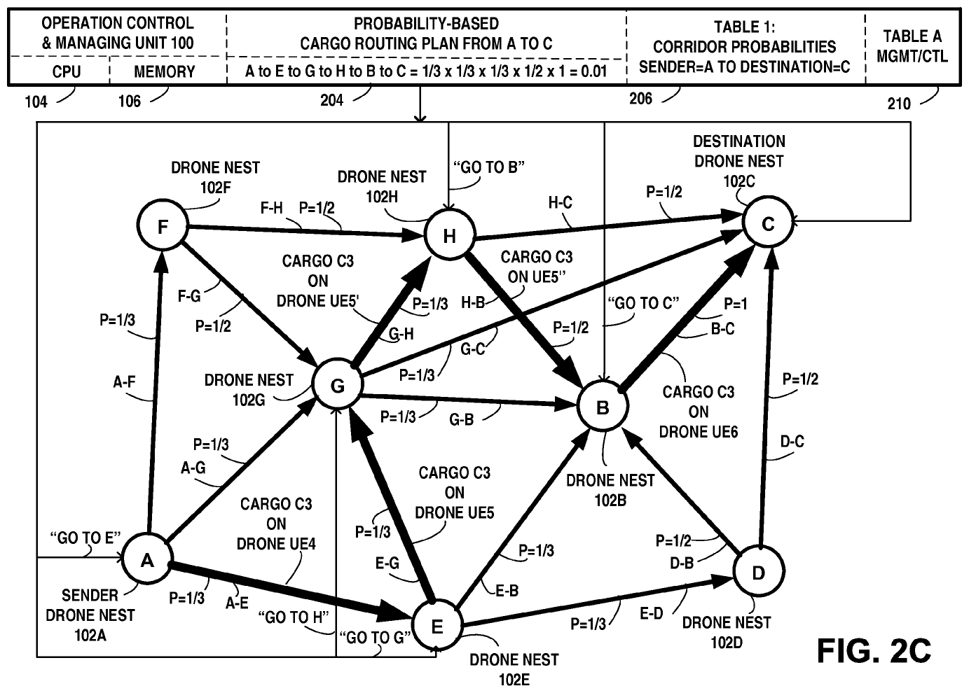

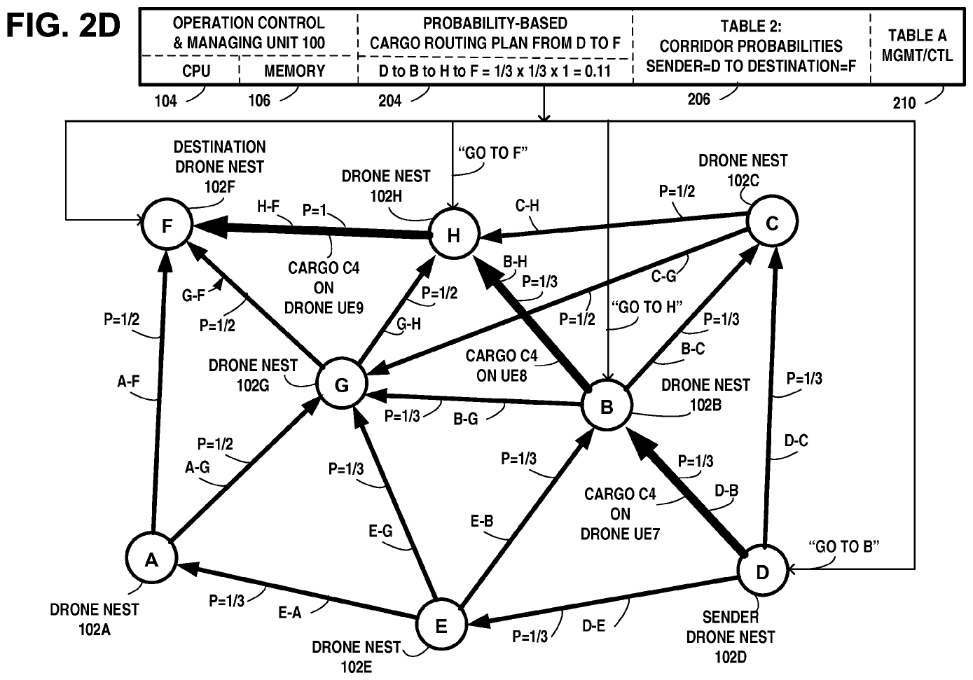

FIG. 2A illustrates an example network diagram of the Drone Nest Network of FIG. 1, illustrating the central controller 100 generating a probability-based package or cargo routing plan. The package or cargo routing plan includes a sequence of forwarding addresses 204 for delivery of cargo by drones, from a sender drone nest station A to a destination drone nest station C, over an indirect route. The indirect route includes drone flight corridors connecting the sequence of drone nest stations A, F, H, and C identified in the sequence of forwarding addresses 204. Each corridor is a dedicated path directed from the departure station to the arrival station. The corridor A-F is a dedicated path directed from station A to station F, where cargo C1 is carried by drone UE1. The corridor F-H is a dedicated path directed from station F to station H, where cargo C1 is carried by a different drone UE2. The corridor H-C is a dedicated path directed from station H to station C, where cargo C1 is carried by drone UE3. Note that a corridor is directed or one-way travel from a departing station. For example, the corridor for a drone departing from station A for arrival at station F is designated A-F. By contrast, the oppositely directed corridor for a drone traveling in the opposite direction, departing from station F for one-way travel to arrive at station A, would be designated F-A.

In an example embodiment of the invention, a bidirectional connection may be provided between drone nest stations, but different routes (corridors) may be used, or even a more than one corridor may be established between two drone nest stations to increase security level. Since the number of possible connections will be higher; additionally, information that a package may be temporarily stored inside a drone nest station may also be provided.

The security level for transporting a package by a drone from a sender to a destination may be characterized as related to the probability that the package will not reach its destination. Without taking preventative measures, an actual security level of a given route between a sender and a destination may be influenced by random adverse factors, such as the presence of vandals, hijackers, adverse weather conditions, and other random adverse factors. If there were no vandals, hijackers, or other adverse factors and if the weather were good, then a package should reach its destination. However, the presence of any of these random adverse factors reduces the security level for transporting a package from the sender to the destination.

However, the security level of a given route may be improved by preventative measures, for example, by using an indirect route, changing the drones carrying a package, or interrupting transport of the package by temporary storage at a drone nest site. Each of these preventative measures reduces the probability that the package will not reach its destination, and thus increases the security level of the route taken. The measure of improvement in the security level provided by such a preventative measure is the reduction in the probability that the package will not reach its destination, which is referred to herein as the “security level improvement factor”.

In an example embodiment of the invention, the probability that a package or cargo attached to a given drone departing from a drone nest station may travel along a particular one of N corridors that are departing from the station, is 1/N. The probability that a package or cargo will travel along the concatenated sequence of corridors in the indirect route is the product of the probabilities for each component corridor in the overall route. For example, the corridors A-F, F-H, and H-C in the indirect route shown in FIG. 2A have the respective probabilities of ⅓, ½, and ½, the product of which is an aggregate probability=0.08, which is the security level improvement factor for the overall indirect route from station A to station C. Additionally, as the package or cargo may be temporarily stored inside the drone nest station, an additional probability equal to ½ may be included in the overall probability budget, which needs to be considered if a cargo or package is not sent over the next drone scheduled period from the given drone nest station.

More than one drone may be departing substantially simultaneously, within a couple of seconds for example, from the given drone nest station, including a false drone (fake flight) in order to mask information that a cargo or package is currently on the flight. In fact, a cargo or package may be still stored in the drone nest station and departure drones may deliver other packages or perform fake flights.

In addition the main purpose to deceive potential hijackers, fake flights, i.e. without a cargo or packages, may be used to support additional services provided by the drone nest network. This may be related with a repetitive nature of such flights over clearly defined drone corridors. An example of such services may be, but is not limited to, a surveillance inspection, air pollution measurements, or any other services available by proper equipage of the drone.

In an example embodiment of the invention, a drone nest network may be adapted to provide an inspection service for railway monitoring purpose (GSM-R). If a drone corridor matches a railway route, when drone is flying over this route, it may also provide vision or other monitoring services. Recorded data may be then downloaded at a drone nest site or delivered as a real time transmission. To support this service, a light weight camera may be needed onboard the drone. The drone may be conducting a fake flight or carrying cargo while providing this service.

In an example embodiment of the invention, a package/cargo may be delivered by the first drone to a given drone nest station, and then the package is assigned to another drone, which is ready for service (battery fully charged and no malfunctions). A recharging process may be done off-line, i.e. after package delivery, the drone's battery may be charged. After this process is completed, the drone may be assigned to another flight, presumably over the same corridor for return flight (with or without another cargo).

In an example embodiment of the invention, FIGS. 2A, 2B, and 2C illustrate three possible indirect package or cargo routes from the sender station A to the destination station C, over corridors that each departs from one station and goes to an adjacent arrival station. The indirect route for cargo C2 carried on drone UE3 in FIG. 2B is from station A to station G to station C (different drones). For example user requirements for the delivery of cargo C2 are that it has a just-in-time delivery at a specified time, and in response the controller 100 generates a shorter indirect route or a cargo or package may be temporarily stored inside specified drone nest station in order to wait for final delivery time. For example, the corridors A to G to C in the indirect route shown in FIG. 2B have the respective probabilities of ⅓ and ⅓, the product of which is an aggregate probability=0.11, which is the security level improvement factor for the overall indirect route from station A to station C.

The indirect route for cargo C3 in FIG. 2C is from station A to station E, to station G, to station H, to station B, to station C and cargo C3 is delivered by different drones. For example, user requirements for the delivery of cargo C3 are that it has a high security delivery, and in response the controller 100 generates a longer indirect route. False drone flights may be enabled to mask the fact of sending a package and to enable temporary cargo or package holding or storing inside a drone nest station. Different drones may be used over different drone corridors to deliver cargo C3. Drone UE4 carries cargo C3 on the A-E corridor. Drone UE5 carries cargo C3 on the E-G corridor. Drone UE5′ carries cargo C3 on the G-H. Drone UE5″ carries cargo C3 on the H-B corridor. Drone UE6 carries cargo C3 on the B-C corridor. For example, the corridors A to E to G to H to B to C in the indirect route shown in FIG. 2C have the respective probabilities of ⅓, ⅓, ⅓, ½, and 1, the product of which is an aggregate probability=0.01, which is the security level improvement factor for the overall indirect route from station A to station C.

A customer (the sender) may, for instance, specify a security level improvement factor to be not worse than 5%, which may also include a “just-in-time” delivery option. The specified security level improvement factor, in the situation shown on FIG. 2A, may require for instance one additional, planed delay on some subroute. For example, the package may stay inside a drone nest site and skip the nearest scheduled drone flight, which creates a lower probability or security level improvement factor of 0.08*0.5=0.04 (4%), which will meet a sender's specification.

In practice, a probability budget may be even further improved, by changing the drone nest network size, number of drones, and other factors discussed herein. An operator of the drone nest network may provide a default security level improvement factor based on a minimal distance between sender and destination sites, which may determine a minimal number of possible subroutes and drone nest sites used. Also, an operator of the drone nest network may propose to a sender improvements in the security level improvement factor, for instance by a factor 10. For example, the default route within the drone nest network gives a probability or security level improvement factor of 4% and an improved security level improvement factor may be then 0.4%. The improvement in the security level improvement factor may be related to extra costs charged for the service. An example of pricing for various security level improvement factors may be:

| | | |
|---|---|---|
| x1—basic deliver “Security | i.e. 4% | package delivery price 100% |
| Level” | | |
| x10—“Security Level” | i.e. 0.4% | package delivery price 102% |
| improved by factor 10 | | |
| x50—“Security Level” | i.e. 0.08% | package delivery price 105% |
| improved by factor 50 | | |
| x100—“Security Level” | i.e. 0.04% | package delivery price 110% |
| improved by factor 100 | | |

Then a sender may decide which security level improvement factor is suitable or how much the sender is willing to additionally pay for such improvement.

Table 1 is an example embodiment of a corridor probability table 206 in memory 106, for indirect routes from the sender station A to the destination station C, listing the probabilities for the various possible corridors. The indirect routes shown in FIGS. 2A, 2B, and 2C use the corridor probability Table 1. The central controller 100 uses corridor probability Table 1, to generate each sequence of forwarding addresses for each of the indirect routes shown in FIGS. 2A, 2B, and 2C. Where there are user requirements for higher levels of security, the central controller 100 selects indirect routes having higher levels of security by including additional route segments in the indirect route, thereby reducing the aggregate probability for the overall indirect route from the sender station A to destination station C. Established corridors may be considered as bidirectional in probability calculations, since packages may travel over them. Additional probabilities may be associated with the event, that a cargo or package is not sent to the next drone nest station despite the fact that this cargo or package is delivered to this station. A factor ½ may be used in case of skipping the next scheduled flight, in overall probability budget.

In an example embodiment of the invention, a different combination of sender station and destination station would use a different corridor probability table 206. For example, FIG. 2D illustrates indirect routes from the sender station D to the destination station F. The indirect route for cargo C4 is on drone UE7 from station D to station B, on drone UE8 from station B to station H, and on drone UE9 from station H to station F. Corridor probability Table 2 in memory 106, shows a different set of probabilities for the various corridors in FIG. 2D for a different set of possible indirect routes from the different sender station D to the different destination station F, over corridors departing from one station and arriving at an adjacent station. The central controller 100 uses corridor probability Table 2 to generate each sequence of forwarding addresses 204 for each of the indirect routes shown in FIG. 2D. Tables 1 and 2 appear as follows:

TABLE 1
(in memory 106)
CORRIDOR PROBABILITY
SENDER = A
DESTINATION = C
(See FIGS. 2A, 2B, 2C)

| CORRIDOR | PROBABILITY |
|---|---|
| A-E | ⅓ |
| A-F | ⅓ |
| A-G | ⅓ |
| B-C | 1 |
| B-D | |
| B-E | |
| B-G | |
| B-H | |
| C-B | |
| C-D | |
| C-G | |
| C-H | |
| D-B | ½ |
| D-C | ½ |
| D-E | |
| E-A | |
| E-B | ⅓ |
| E-D | ⅓ |
| E-G | ⅓ |
| F-A | |
| F-G | ½ |
| F-H | ½ |
| G-A | |
| G-B | ⅓ |
| G-C | ⅓ |
| G-E | |
| G-F | |
| G-H | ⅓ |
| H-B | ½ |
| H-C | ½ |
| H-F | |
| H-G | |

TABLE 2
(in memory 106)
CORRIDOR PROBABILITY
SENDER = D
DESTINATION = F
(See FIG. 2D)

| CORRIDOR | PROBABILITY |
|---|---|
| A-E | |
| A-F | ½ |
| A-G | ½ |
| B-C | ⅓ |
| B-D | |
| B-E | |
| B-G | ⅓ |
| B-H | ⅓ |
| C-B | |
| C-D | |
| C-G | ½ |
| C-H | ½ |
| D-B | ⅓ |
| D-C | ⅓ |
| D-E | ⅓ |
| E-A | ⅓ |
| E-B | ⅓ |
| E-D | |
| E-G | ⅓ |
| F-A | |
| F-G | |
| F-H | |
| G-A | |
| G-B | |
| G-C | |
| G-E | |
| G-F | ½ |
| G-H | ½ |
| H-B | |
| H-C | |
| H-F, | 1 |
| H-G | |

In the present example shown in FIG. 2A, the controller 100 manages a plurality of eight drone nest stations 102 distributed over a geographical area. Each pair of adjacent stations is connected by at least two oppositely directed corridors. Each corridor probability table 206, such as Table 1, applies to an overall delivery path from a specific sender station to a specific destination station. Thus, the number of corridor probability tables 206 used by the controller 100 for all possible combinations of sender to destination stations, is the number permutations of eight stations taken two at a time, which is 56. In this example, the controller 100 stores and uses 56 corridor probability tables 206, such as Table 1, for all possible combinations of sender to destination stations.

In an example embodiment of the invention, more corridors may be established between two stations to provide higher redundancy or higher security level. A direct flight between two stations may be enabled, with the route agreed to between the two stations and approved by the central controller, in order to minimize a risk of spontaneous hostile actions or overflights over sensitive areas. For each corridor, a predefined drone flight route between the two stations may be agreed to by the two stations. The address of the next station may be loaded by the departure station in the drone's memory. Flight route selection may be done by a reference to previously stored flight routes in the station, so that the flight route is not provided over a radio interface that might be overheard by hijackers.

In an example embodiment of the invention, the controller 100 is able to manage substantially simultaneously, within seconds or within parts of seconds for example, active drone flight routes with the Management and Control Table 210 in memory 106, shown in Table A. Each unit of cargo, packages or other goods scheduled for delivery from a sender station to a receiver station, is assigned a probability-based drone routing plan that includes a sequence of forwarding addresses 204 for delivery of the cargo by drones, from the sender station to the destination station over an indirect route. The indirect routes use a corridor probability table 206, such as Table 1. The central controller 100 uses the corridor probability table 206 to generate the sequence of forwarding addresses 204 for the indirect route and to transmit the forwarding address to the current station where the cargo is located. Where there are user requirements for higher levels of security, the central controller 100 selects indirect routes having higher levels of security by including additional route segments or corridors in the indirect route, initiate fake flights or enable cargo or package temporary storing inside drone nest station. The Management and Control table 210, Table A, has columns for the Cargo ID/User Requirements, the Sender and Destination Stations, Indirect Route the sequence of forwarding addresses 204 for the indirect route, the Overall Probability of the indirect route, the Current Station along the indirect route where the cargo is currently located, the Current Drone carrying the cargo, the Current Blockchain record of the previous path of stations that have transferred the cargo from the sender station to the current station, and the Next Station. Table A appears as follows:

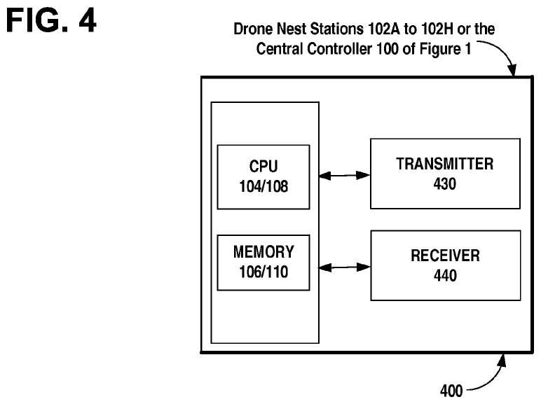

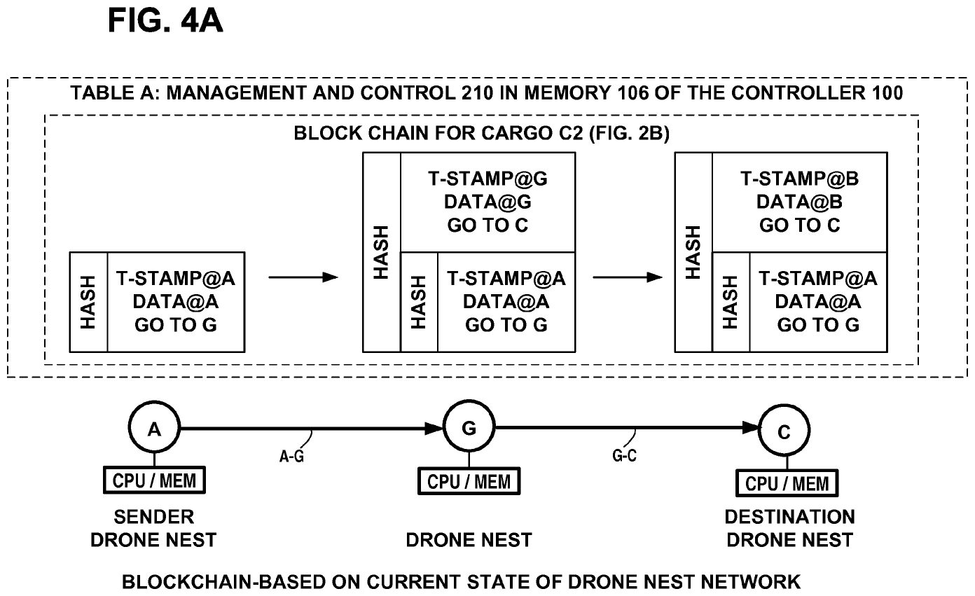

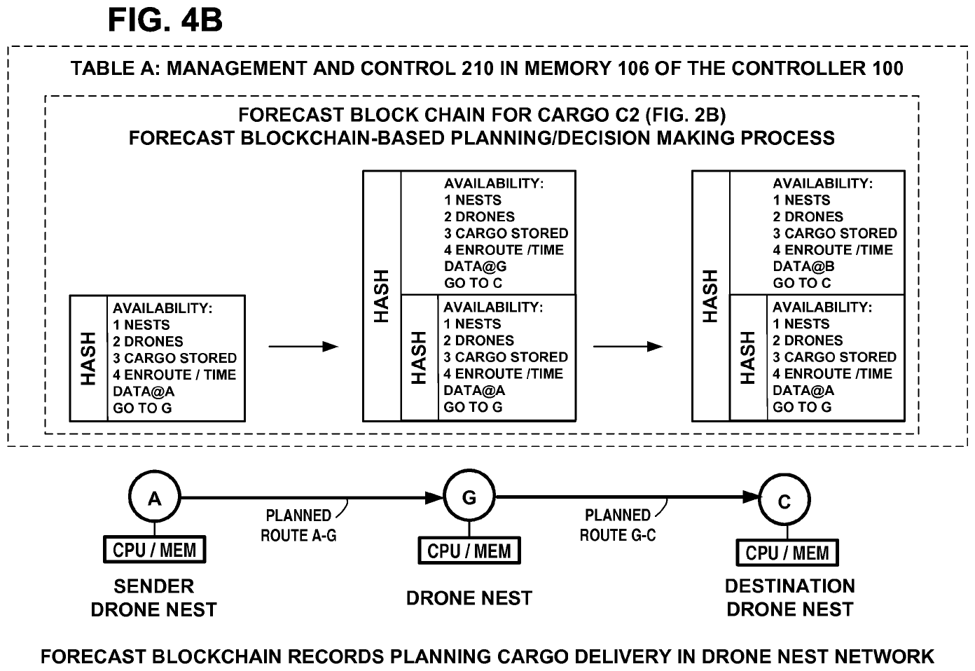

TABLE A
MANAGEMENT AND CONTROL (in memory 106)

| Cargo | | | | | | Current | |
|---|---|---|---|---|---|---|---|
| ID/User | Sender/ | | Overall | Current | Current | Blockchain | Next |
| Requirements | Destination | Indirect Route | Probability | Station | Drone | (FIG. 4) | Station |
| C1 (FIG. 2A)/ | A-C | A to F to H to C = | 0.08 | F | UE2 | Hash[(F) | H |
| Normal | | ⅓ × ½ × ½ = | | | | Hash(A)] | |
| Delivery | | 0.08 | | | | | |
| C2 (FIG. 2B)/ | A-C | A to G to C = | 0.11 | A | UE3 | Hash[(A)] | G |
| Just-in-time | | ⅓ × ⅓ = 0.11 | | | | | |
| Delivery | | | | | | | |
| C3 (FIG. 2C)/ | A-C | A to E to G to H | 0.01 | B | UE6 | Hash[(B) | C |
| High Security | | to B to C = | | | | Hash(HGEA) | |
| Delivery | | ⅓ × ⅓ × ⅓ × | | | | Hash(GEA) | |
| | | ½ × 1 = 0.01 | | | | Hash(EA) | |
| | | | | | | Hash(A)] | |
| C4 (FIG. 2D)/ | D-F | D to B to H to F = | 0.11 | D | UE7 | Hash[(D)] | B |
| Normal | | ⅓ × ⅓ × 1 = | | | | | |
| Delivery | | 0.11 | | | | | |

In an example embodiment of the invention, an apparatus for secure delivery of package or cargo, comprises:

at least one processor;

at least one memory including computer program code;

the at least one memory and the computer program code configured to, with the at least one processor, cause the apparatus at least to:

plan routes between different destinations and stations for secure package or cargo delivery, including alternative subroutes between the stations;

measure probabilities for traversing the different routes and alternative subroutes between the different stations for secure delivery of package or cargo, and

select one or more of the different routes or alternative subroutes whose measured probability provides a required level of security for delivery of package or cargo.

In an example embodiment of the invention, the at least one memory and the computer program code configured to, with the at least one processor, cause the apparatus at least to:

select one or more alternative vehicles for delivery of package or cargo to be used in the one or more selected different routes or alternative subroutes.

In an example embodiment of the invention, the at least one memory and the computer program code configured to, with the at least one processor, cause the apparatus at least to:

determine availability of one or more vehicles one or more of the different routes or alternative subroutes for delivery of package or cargo.

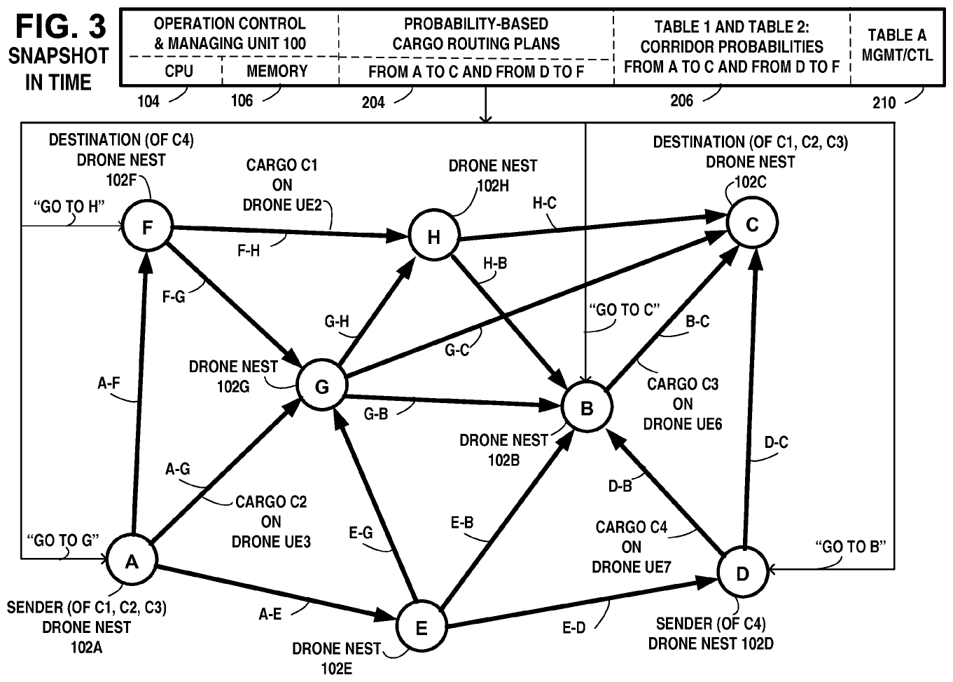

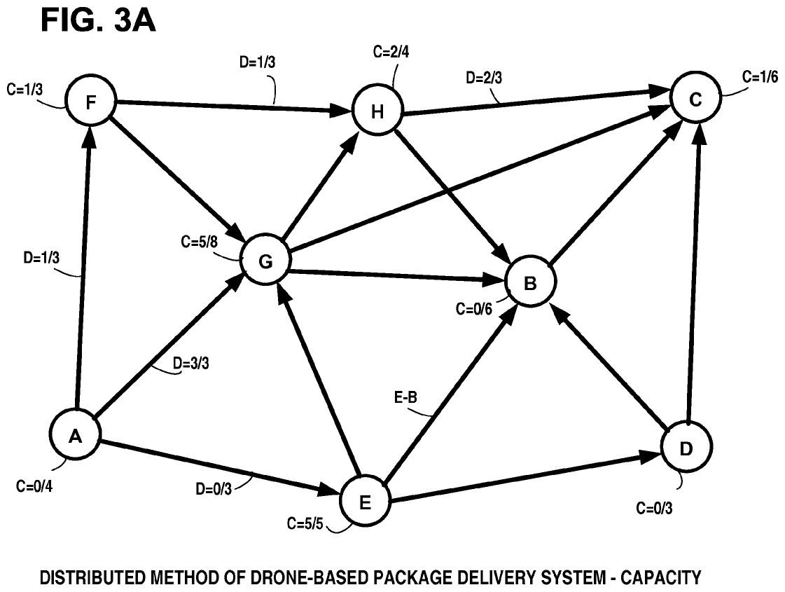

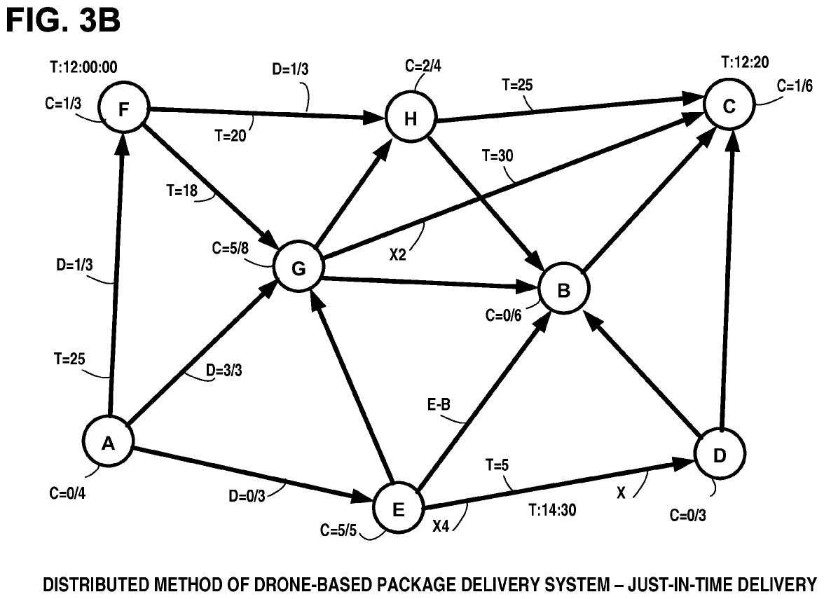

FIG. 3 illustrates an example network diagram of the Drone Nest Network of FIG. 1, illustrating a current snapshot in time of the central controller 100 generating two different probability-based drone routing plans 204 for two different sender drone nest stations A and D to two different destination drone nest stations C and F. Station A is the sender station and station C is the destination station for three units of cargo, C1, C2, and C3. The snapshot in time of FIG. 3 shows substantially simultaneously occurring flights of cargo C1 departing on drone UE2 from station F, cargo C2 departing on drone UE3 from station A, and cargo C3 departing on drone UE6 from station B, based on the corridor probability Table 1. Station D is the sender station and station F is the destination station for cargo C4. The snapshot in time of FIG. 3 shows cargo C4 departing on drone UE7 from station D, based on the corridor probability Table 2.

Distributed Mode Model of Drone Nest Network

In an example embodiment of the invention, a distributed mode model of drone nest network method delegates to the local drone nest station logic, the execution of package or cargo delivery. Initially, the centralized controller generates the sequence of addresses for delivery of cargo over an indirect route between a sender station and a destination station. A station receives a next address for a next station that was planned by the central controller. However, changes in conditions, such as local changes in weather, traffic, or availability of drones, which may require modifying the initial selection of the next station, will be processed by the local departure station.

When the next drone nest station is indicated for the given cargo or package, local departure drone nest station logic may request changes in the cargo or package sequence of addresses related to delivery. This action may be justified in case of changes in drone nest network status, drone availability, weather or environmental issues, presence of other cargo at the departure or at the next station or on the way, the status of adjacent drone nest stations (availability, cargo space) and other factors that cannot be predicted by Central Controller at the time delivery was requested by a Sender and initial cargo or package delivery plan was prepared.

In the distributed mode model, each drone nest station has logic responsible for local package or cargo managing and distribution. The drone nest stations within the network may be connected to each other as a peer-to-peer (P2P) network, in which they may exchange required statuses and autonomously decide about the next flight segment of the given package or cargo, based on required local changes to the next address initially provided by the central controller. The advantage of this solution is very high resistance and redundancy, in case of damage to the network, since local dispatching of drone flights may be still provided. Also, no connection to the Central Controller may be required, at least when the next segment of package or cargo delivery has been agreed to between the local departure drone nest station and next drone nest station, or at least one of them.

The local departure drone nest station may provide feedback to the Central Controller of the changes in the initial selection of the next station. The local departure drone nest station may request cargo or package delivery routing plan update or confirmation from the Central Controller. In example embodiments, the local departure drone nest station may autonomously enforce a new cargo or package delivery plan to the same or another next station in the drone nest network. In any case, the Centralize Controller will be made aware of any revision to the current cargo or package route delivery plan and may update further plans and may also update the overall state of drone nest network.

Enhanced security of package or cargo drone-based transportation may be achieved multiple factors such as: selection of indirect routes, purposeful delays, just in time delivery, fake flights, blockchain processing, forecasted blockchain-based decision making process, simultaneously drone operations, resistance to drone interception by usage of predefined flight plans, protection of user sensitive data, usage of standardized package boxes and cargo compartments.

FIG. 3A illustrates an example network diagram of the Drone Nest Network of FIG. 1, illustrating handling cargo capacity in the distributed mode model of drone-based package delivery system. In the distributed mode model, the local departure station may determine that local changes in weather, traffic, or availability of drones, may require changes in the local routing to a next station, changing the initial selection of the next station that was made by the central controller, in accordance with an example embodiment of the invention.

The probabilities associated with multiple packages or cargos being carried by a given drone along a particular drone corridor are shown in FIG. 3A. A package route selection should take into consideration at least following variables:
Number and current position of all other packages carried by drones used in this Method, as shown on FIG. 3A,
Availability of drone nest stations with respect to maximum package capacity of the given drone nest stations, as shown on FIG. 3A,
Available Number of drones at the given site, as shown on FIG. 3,
Drone flight schedule, as shown on FIG. 3B,
Possible package bundled transportation, if feasible, as shown on FIG. 3B,
Requested by the User package security level (if specified), as shown on FIG. 3A, and
Package requested (if specified) delivery time, as shown on FIG. 3B.

In FIG. 3A, multiple packages or cargos being carried by a given drone are designated as follows:
C=n/N—package capacity of the given drone nest station; n—current number of stored packages, N—maximum number of stored packages;
D=n/N—package drone cargo compartment capacity of the given drone; n—current number of transported packages, N—maximum number of transported packages.
Station's capacity C and drone cargo compartment's capacity D may depend on deployment issues.

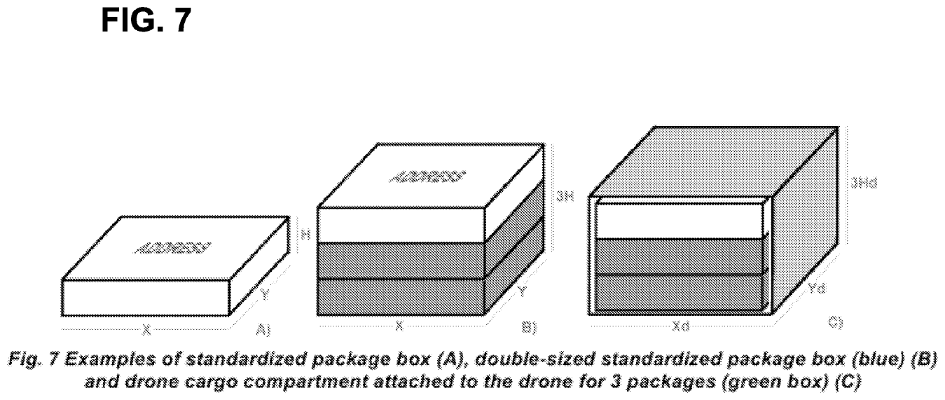

With respect to the dynamic view shown in FIG. 3A, the current Drone Nest Network state may be illustrated as follows:
Currently, in FIG. 3A, there are 21 standardized packages in the Drone Nest Network (7 packages are carried by drones, 14 stay inside Drone Nest stations).
Currently in FIG. 3A, there are no packages at the Station A (C=0/4), and there is no free package capacity at the Station C (C=5/5), and there is one package at the Station F (C=¼).
Currently, in FIG. 3A, 3 drones start from the Station A: drone on the route to the Station F carry 1 package (D=⅓) (package of interest), drone on the route to the Station G carries 3 packages (D=3/3)—for one of them a higher security level may be requested, and drone on the route to the Station E carry 0 packages (D=0/3)—this may be a fake flight.
By referring to cargo or package, it should be clearly defined that each user package or cargo sent by the drone-based delivery service is encapsulated inside a standardized package box, which size and dimensions match the drone cargo compartments, as illustrated on FIG. 7. Standardized package boxes may be shielded against electromagnetic (EM) emissions, if such feature is associated with the carried package. Moreover, standardized package boxes provide additional protection for a delivered cargo or package in case of a drone crash, including protection against humidity or liquid water. Additionally, by using standardized package boxes, and also shielded drone cargo compartments, an outside observer (potential hijackers) may not be able to confirm whether the given drone is carrying of the specified cargo or package, or even if it is carrying any cargo or package.
In case of a high security level package sent from the Station A in FIG. 3A, a fake flight may be initiated, and another package may be sent to the Station F.
Currently, in FIG. 3A, the Station G reaches its maximum capacity when a drone arriving from the Station A delivers it's carried packages.
In case of the Station C in FIG. 3A, which has maximum capacity equal 4 packages, some packages must be sent (to the Station C) to prepare a place for incoming packages delivered by drone sent from the Station F.
Currently, the Station E in FIG. 3A cannot receive any packages, as it reached its maximum capacity.

Drones operated within Drone Nest Network do not compete with each other for resources such as availability of charging platform of shelters, as each drone may have clearly dedicated host station, which may also include drone recharging issues as offline service.

FIG. 3B illustrates an example network diagram of the Drone Nest Network of FIG. 1, illustrating just-in-time delivery in the distributed mode model of drone-based package delivery system, in accordance with an example embodiment of the invention.

In FIG. 3B a “just in-time” package delivery concept is illustrated. As it may be seen, this also has impact on package distribution within the network. With respect to the present example, it may be specified, with respect to system time e.g. 12:00:00 that:
One of the packages carried by drone UE4 should be delivered to the Station C not later than T: 12:20, which means that at 12:00:00 the package should be already in the air, as it takes t=25 minutes to travel by drone distance from the Station H to the Station C.
One of the packages from the Station E should be delivered to the User location X at T: 14:30, which means that because the flight from the Station E will take up to t=5 minutes, this package may be stored inside Drone Nest station E compartment until the time 14:25:00.
If necessary and justified, a package from the Station E, which should be delivered at T: 14:30 may be temporarily relocated to other stations to free the Station E capacity.
In case of 3 packages at the Station G, delivery time has not been specified, which means these packages may wait for transfer toward destination point when a flight will be scheduled,
In case of 2 packages carried between stations G and B, also delivery time has not been specified, but a drone was ordered to a flight in the delivery direction, and there was a space in drone cargo compartment, which means these packages could be sent. What is also important is that at the Station G there is a free space to handle these packages, and potentially store them.

With respect to a drone availability issue at a drone nest station, a higher number of drones ready to service may increase security of package delivery, as more drones may fly, for instance substantially simultaneously from the given station, which has impact on probabilities of route selection. This is illustrated in FIG. 3 in case of the Station A

Drone availability has also an impact on drone flight schedules. Taking into account a drone's flight duration (FIG. 3B) and drone recharging time, it may be possible to determine an optimal flight roster. This has impact also on security aspect, as provision of more frequent flights between stations supports security of package delivery.

In general, the drone recharging process has minimal impact on delivery of current cargo or package, but it may have an impact on drone overall availability and its ability to perform a next flight, with cargo or not, over the next specified drone corridor. The next specified drone corridor may be related to a return path in order to support association of drones with the given drone nest station, which reflects current drone nest station drone capacity (i.e., the number of hosted drones and availability of drone boxes for incoming drones' accommodation and recharging). The size (capacity) of a drone nest station depends on performance requirements and a number of potential established corridors.

Also, different types of drones may be used over specified drone corridors (called trunk corridors or trunk connections). Due to performance requirements, a higher number of cargo or package items may be requested to be delivered using particular drone nest stations. In that case, drones may be required to simultaneously carry a higher number of packages in standardized boxes, conduct more frequent flights, or conduct substantially simultaneous flights over the same corridor, in swarm or the like, for example.

The example embodiments of the invention provide a higher package security level when more complex drone nest stations are used. More drones may be deployed to provide service and more packages may be delivered by the Drone Nest Network, as these factors may have impact on package route selection.

FIG. 4 illustrates an example computing device 400, which may be a component of, for example, the one or more of the drone nest stations 102A to 102H or the central controller 100 of FIG. 1. Comprised in device 400 is CPU processor 104 for the central controller 100 and CPU processor 108 for one or more of the drone nest stations 102A to 102H, which may comprise, for example, a single- or multi-core processor wherein a single-core processor comprises one processing core and a multi-core processor comprises more than one processing core. Processor 104/108 may comprise, in general, a control device. Processor 104/108 may comprise more than one processor. Processor 104/108 may be a control device. A processing core may comprise, for example, a Cortex-A8 processing core manufactured by ARM Holdings or a Steamroller processing core produced by Advanced Micro Devices Corporation. Processor 104/108 may comprise at least one Qualcomm Snapdragon and/or Intel Atom processor. Processor 104/108 may comprise at least one application-specific integrated circuit, ASIC. Processor 104/108 may comprise at least one field-programmable gate array, FPGA. Processor 104/108 may be means for performing method steps in device 400. Processor 104/108 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 400 may comprise memory 106 for the central controller 100 and memory 110 for one or more of the drone nest stations 102A to 102H. Memory 106/110 may comprise random-access memory and/or permanent memory. Memory 106/110 may comprise at least one RAM chip. Memory 106/110 may comprise solid-state, magnetic, optical and/or holographic memory, for example. Memory 106/110 may be at least in part accessible to processor 104/108. Memory 106/110 may be at least in part comprised in processor 104/108. Memory 106/110 may be means for storing information. Memory 106/110 may comprise computer instructions that processor 104/108 is configured to execute. When computer instructions configured to cause processor 104/108 to perform certain actions are stored in memory 106/110, and device 400 overall is configured to run under the direction of processor 104/108 using computer instructions from memory 106/110, processor 104/108 and/or its at least one processing core may be considered to be configured to perform said certain actions. Memory 106/110 may be at least in part comprised in processor 104/108. Memory 106/110 may be at least in part external to device 400 but accessible to device 400.

Device 400 may comprise a transmitter 430. Device 400 may comprise a receiver 440. Transmitter 430 and receiver 440 may be configured to transmit and receive, respectively, information in accordance with at least one cellular or non-cellular standard. Transmitter 430 may comprise more than one transmitter. Receiver 440 may comprise more than one receiver.

Current Blockchain Record of Previous Route

FIG. 4A illustrates an example of blockchain generation by the central controller 100, to generate a current blockchain record of the previous path of stations traversed by the cargo from the sender station to the current station, in accordance with an example embodiment of the invention. The blockchain is based on the current state of the drone nest network. The blockchain is a growing list of records or blocks, each block containing a cryptographic hash of the previous block, a timestamp, and transaction data. The cryptographic hash makes the blockchain record resistant to modification of the data it contains. Once recorded, the data in any given block cannot be altered retroactively without alteration of all subsequently generated blocks.

The figure shows an example of how the controller 100 generates a block chain record for the cargo C2 as it traverses the stations A to G to C in FIG. 2B. Starting with the cargo C2 at station A, a first cryptographic hash value is generated on a combination of a timestamp at A, any data to be recorded at A, and the address “go to G” of the next station G. The first cryptographic hash value is then stored in Table A: Management and Control 210 in memory 106 of the controller 100. After arrival at the next station G of the cargo C2 carried by a drone UE3, the station G reports the arrival to the controller 100. The controller 100 then generates the forwarding address to the next station G. The controller 100 then augments the first blockchain record for the cargo C2 at station G, by computing a second cryptographic hash value on a combination of the first cryptographic hash value, a timestamp at G, any data to be recorded at G, and the address “go to C” of the next station C. The second cryptographic hash value is then stored in Table A: Management and Control 210 in memory 106 of the controller 100. In this manner, an historical record is recorded of the actual path traversed by the cargo C2 from stations A to G to C in FIG. 2B.

Forecast Blockchain Record of Planned Route

FIG. 4B illustrates an example of blockchain generation by the central controller 100, to generate forecast blockchain records planning for cargo delivery in the drone nest network. In accordance with an example embodiment of the invention, a blockchain-based planning and decision-making process may be used to indicate a predicted level of cargo or package delivery security.

Blockchain generation by the central controller 100 may be applied to the sequence of next addresses initially generated by the central controller for an initially planned indirect route of cargo. The central controller generates the probability-based drone routing plan for the cargo, which includes the planned sequence of forwarding addresses for delivery of the cargo by drones, from a sender drone nest station to a destination drone nest station over an indirect route.

In an example embodiment of the invention, in FIG. 4B, the forecast blockchain uses as its argument, the sequence of next addresses initially generated by the central controller for an initially planned indirect route of the cargo. The forecast blockchain is a growing list of records or blocks, for example, each block corresponds to a sequential one of the stations A, G, and C forwarding the cargo C2 on the indirect route in FIG. 2B. Each block for a given forwarding station A, may contain contents, for example, the next address G in the sequence, the availability of next stations, the availability of drones, the number of arriving packages of the cargo that are expected to be received from a previous station, the number of packages of the cargo waiting inside the station A, which should also be forwarded to the next station G, and the delivery time requirements for the cargo. For the original sender station A in the sequence of the stations A, G, and C of the overall indirect route, a cryptographic hash of the contents of the first forecast blockchain record block is computed for station A. The first forecast blockchain record block includes the contents for station A and the computed hash value for station A. The first forecast blockchain record block is then stored in Table A: Management and Control 210 in memory 106 of the controller 100.

In FIG. 4B, then a second forecast blockchain record block is initially generated by the central controller for the next station G in the sequence of the stations A, G, and C of the overall indirect route. The second forecast blockchain record block may contain, for example, the second next address C in the sequence, the availability of second next stations at the next station G, the availability of drones at the next station G, the number of arriving packages of the cargo at the next station G, which are expected to be received from the previous station A, the number of packages of the cargo waiting inside the next station G, which should also be forwarded to the second next station C, and the delivery time requirements for the cargo. The controller 100 then augments the second forecast blockchain record block for the cargo C2 at station G, by computing a second cryptographic hash value on a combination of the first forecast blockchain record block and the contents of the second forecast blockchain record block. The second forecast blockchain record block includes the contents for station G and the computed second cryptographic hash value for station G. The second forecast blockchain record block is then stored in Table A: Management and Control 210 in memory 106 of the controller 100.

The cryptographic hash makes the blockchain record resistant to modification of the data it contains. Once recorded, the data in any given block cannot be altered retroactively without alteration of all subsequently generated blocks.

The Central Controller, or any local Drone Nest station logic, may propose a probabilistic-based package or cargo delivery route plan, which may include start and final drone nest station and a number of intermediate drone nest stations, all defined based on actual overall Drone Nest Network state/status. Selected stations, routes, and times may be predicted, and if there will be no complications, a package or cargo may be delivered as specified. The predefined, forecast blockchain record may predict allocations of cargo space, drone availability, flight roster etc. The forecast blockchain record provides a predictable course of events in the delivery of the cargo. Of course, any unpredictable changes in the delivery may occur, and the forecast blockchain record may be accordingly modified or a new forecast blockchain record may be created by the central controller, related to this package delivery.

A blockchain-based decision-making process may be used when the distributed mode model is applied and local drone nest station logic alters a cargo or package delivery plan. The blockchain-based decision-making process may be based on the current and recorded historical state of the drone nest network, as recorded in the blockchain records of previous package delivery steps. A further logic decision may be triggered by the blockchain-based decision-making process made with respect to route selection. The blockchain-based decision-making process may use a blockchain record of previous package delivery, and also may use the forecast of the next blockchain entries in the forecast blockchain record to revise an overall indirect route.

The forecast blockchain record provides a new, blockchain-based decision-making process, in which forecast blockchain records may be received from many sources, to optimize performance of the drone nest network. For example, factors may be included in the forecast blockchain record, such as package bundling, additional routes between the same stations or more frequent drone flights, drones relocation between stations, alternative paths, etc. This way typical for blockchain data security may be used both for historical data recording and also for forecasting of system behavior, managing and optimization.

In an example embodiment of the invention, the forecast blockchain record may be used in a method to plan secure delivery of package or cargo. The method uses the controller to select either a first probability-based package or cargo routing plan for a first level of security or a second probability-based package or cargo routing plan for a second level of security, based on a required level of security for delivery of the package or cargo.

The method includes generating, by the controller of a plurality of stations distributed over a geographical area, a first probability-based package or cargo routing plan for a first level of security, the first plan including a first sequence of planned forwarding addresses for delivery of cargo to a first sequence of stations, from a sender station of the plurality of stations to a destination station of the plurality of stations over an indirect route including corridors connecting the plurality of stations identified in the sequence of forwarding addresses.

The method includes generating, by the controller, a first forecast blockchain record for each of the plurality of stations in the first sequence from the sender station to the destination station, each first forecast blockchain record contents including at least a planned next forwarding address of a next station in the first sequence of planned forwarding addresses and information related to alternate next stations, the controller computing a cryptographic hash value on a combination of a previous forecast blockchain record computed for a next previous station in the sequence and the contents of the first forecast blockchain record.

The method includes generating, by the controller of the plurality of stations distributed over the geographical area, a second probability-based package or cargo routing plan for a second level of security, the second plan including a second sequence of planned forwarding addresses for delivery of cargo to second sequence of stations, from a sender station of the plurality of stations to a destination station of the plurality of stations over an indirect route including corridors connecting the plurality of stations identified in the sequence of forwarding addresses.

The method includes generating, by the controller, a second forecast blockchain record for each of the plurality of stations in the second sequence from the sender station to the destination station, each second forecast blockchain record contents including at least a planned next forwarding address of a next station in the second sequence of planned forwarding addresses and information related to alternate next stations, the controller computing a cryptographic hash value on a combination of a previous forecast blockchain record computed for a next previous station in the sequence and the contents of the second forecast blockchain record.

The method concludes by selecting, by the controller, either the first probability-based package or cargo routing plan for the first level of security or the second probability-based package or cargo routing plan for the second level of security, based on a required level of security for delivery of the package or cargo.

In an example embodiment of the invention, a time marker may be used as part of forecast blockchain as one of entry value. In this case this time may correspond to scheduled or planned package sending from the given site, as drones may operate according a roster. In some cases, a drone may wait for delivery of few packages to the site and then it will start the flight. As such, a departure time may be estimated as drone operates on known corridors, so it may be possible to estimate in each case when a package will be send to the next site.

In forecast blockchain, more important in this case will be package sending time, whereas in typical blockchain, more important may be package delivery time, as this is a concrete time stamp.

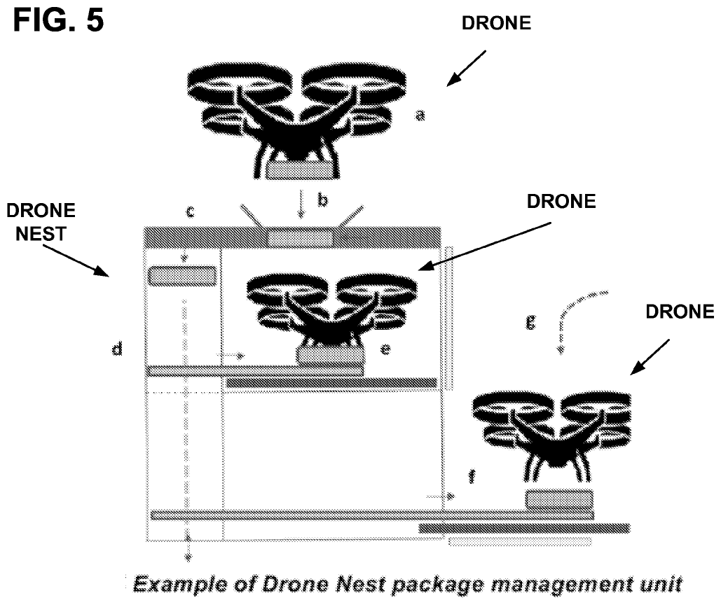

FIG. 5 illustrates an example of a drone nest package management unit, in accordance with an example embodiment of the invention. The functions of the drone nest package management unit are controlled by a program stored in the memory 110 and executed by the CPU 108 of the drone nest station.

A drone with a package is approaching the unloading platform, which may be located on the top of the drone nest station (a). When on exact location, drone may drop carried packages (b). Packages are transported inside drone nest station. Each package may be scanned (c) to reveal its destination and determination of the next route. If a package should be delivered to the next drone nest station, it is delivered to the box occupied by drone, which operate on this route (d). Package is loaded to drone cargo compartment (e).

A cargo may be also delivered on the ejected moving platform (f), from where it may be taken by hovering drone (g), which carries it to the next station.

The highest security solution is when a drone with cargo (g) arrives on ejected platform (f), and then is pulled into drone box, where package or packages are unloaded (e). In such situation, package distribution is done entirely inside drone nest station compartment, which prevents detecting which drone will carry the package over the next route.

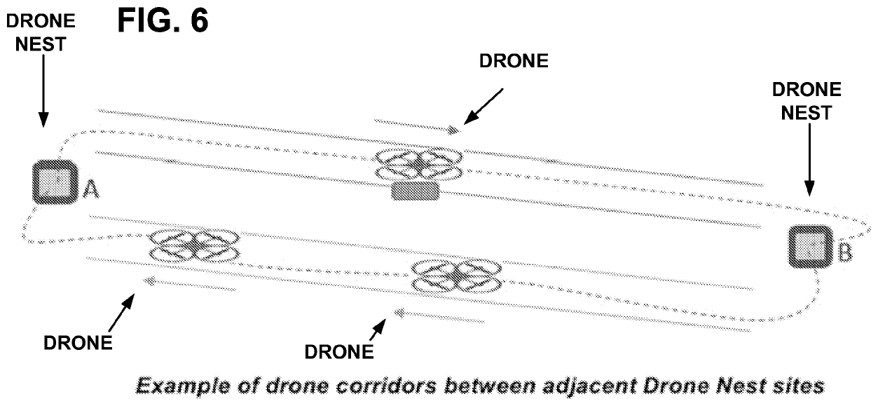

FIG. 6 illustrates an example of drone corridors between adjacent drone nest stations, in accordance with an example embodiment of the invention.

In accordance with an example embodiment of the invention, drones are operated always on clearly defined connections between two adjacent drone nest stations denoted as “drone corridors”. A drone corridor may be operated by one or many drones independently travelling over this distance. A package may be carried over this part of the route in any acceptable for drone operations weather conditions and in with any allowed package maximum weight.

More than one drone corridor may be established between two adjacent drone nest stations.

The length of drone corridor depends on drone power source capabilities and also is calculated for maximum allowed cargo weight and negative weather impact. This restriction may have impact on drone nest station site deployment, but in many cases, it may be compliant with currently existent infrastructure.

At the first (when the package may be picked up from the starting point) and the last (when the package may be delivered to the recipient station) stage of package delivery, drones may operate on the route between the starting/delivering point and the nearest drone nest station site.

In accordance with an example embodiment of the invention, drones may deliver packages flying over clearly defined routes called corridors or trunk connections. Such routes may be designed and agreed to with local authorities to minimize negative impact of drone operations on people, safety, and privacy, and may be aligned, for instance, with urban vehicle routes, which are normally public routes and may be monitored. This solution also minimizes the risk of any illegal actions taken against drones by hostile parties or unhappy citizens.

For further security and safety of package delivery, a drone corridor may be restricted to specified dimensions (drone flight height and deviation from the assigned route) and corridors may by unidirectional. Any deviation from the assigned corridor may be reported and investigated by drone operator.

FIG. 7 illustrates an example of a standardized package box (A), double-sized standardized package box (B) and drone cargo compartment attached to the drone for 3 packages, in accordance with an example embodiment of the invention. Standardized means, primarily, that boxes or envelopes are substantially similar looking, so that the content of the package cannot be recognized.

The purpose of standardization is to enable package loading and unloading in autonomic manner. For this purpose each carried package should have dimensions which support carriage by drones (vehicles). The exact size may be related to type of drones, drone box size and other aspects.

A standardized package box provides protection to carried user package as it may not be possible to see what is inside, so there is no need to determine what user can send by drone in order to avoid recognition. Also standardized package box may provide electromagnetic (EM) shielding, so even if a user attaches to carried package some tracking device its signal may be blocked.

The size of a user package should match the size of a standardized package box. An additional requirement may be limitation of package weight to allow drone transportation.

If needed, a double or triple-sized standardized package box may be used (or even bigger, subject of deployment) to handle a user package with higher dimensions.

In accordance with an example embodiment of the invention, a package transported by drones may be protected in case of drone crash and possible unauthorized access, when such abnormal situation occurs. For this reason, a standardized package box is shown on FIG. 7 (A). Additionally, drone cargo compartment may be also provided protection in this situation, as presented on FIG. 7 (C).

Due to weight limits, package protection provided by drone cargo compartment and package standardized box may not be sufficient to protect carried packages against any illegal access. The assumption is that even if drone falls, the content stays inside drone cargo compartment, or at least inside package box. In such case, a typical casual finder, or drone management operational staff, may collect debris and possibly continue package delivery, without the risk that the package content having been compromised.

Standardized package boxes provide also protection against user package visual observation, as outside observer may not be able to determine if the given package or any package is stored inside standardized box during a flight.

Additional protection may be provided by electromagnetic shielding of the drone cargo box and package standardized box, which may prevent unauthorized package tracking. Information about where currently is located given package should be pure drone operator issue, as such information may be sensitive.

Package box standardization means that package box dimensions should be compliant with drone cargo compartment. A package box may have defined dimensions and features (X, Y, H), which at least support provision of package delivery data on it.

To handle a bigger user package, a higher box may be used, but one dimension should be changed by natural multiplication e.g. (X, Y, 2H) as illustrated on FIG. 7 (B)—double-sized standardized package box.

Drone cargo compartment may have bigger dimensions than standardized package box and may be able to store during flight agreed number of standardized package boxes, for instance 3 units FIG. 7 (C). Packages may be loaded or unloaded using front or bottom drone cargo compartment partition depends on applied package loading/unloading model as illustrated on FIG. 5.

Depending on configuration, drone cargo compartment may be fixed mounted to the drone or be portable.

Standardized package boxes inside drone cargo compartment may be protected against accidental falling or slipping out.

The package may be delivered to the drone nest network (directly by user to drone nest site node or by requesting a package to be picked up from specified location). In each case delivery data should be inserted on standardized package box envelope as shown on FIG. 7. From the Drone Nest Network logic package may be tracked by Package ID allocated by central controller or in distributed mode when package is delivered to the site or delivery service were requested. Also, package ID may be used to associate necessary data to package final delivery (or also such data may be provided on envelope and may by for instance scanned by station logic.

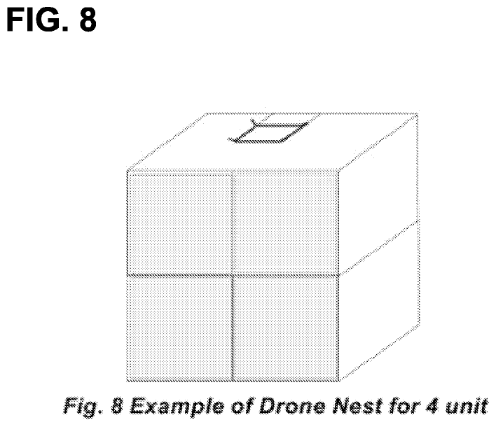

FIG. 8 illustrates an example of a drone nest for 4 units, in accordance with an example embodiment of the invention.

The drone nest concept introduces a multi-drone storage and charging complex, where many drones may be waiting for assignments and performing scheduled flight between adjacent drone nest station, and where packages may be unloaded, put into evidence, stored, distributed and loaded to the next drone in a secret and security way.

Due to the modular form of drone box a higher number of drone boxes may be co-located in many configurations. Each drone box has the size adequate to accommodate a drone equipped with drone cargo compartment and associated package management components. Drone boxes may have solid construction and security alarms to prevent unauthorized access.

In accordance with an example embodiment of the invention, drones and packages may be stored inside drone nest station compartments to improve package security level. This has significant impact on drone box dimension and entire size of drone nest station. The size of the drone itself includes any rotating parts. in an example embodiment of the invention, when a drone arrives at a drone nest ejected platform, its rotating parts may be folded up, for example, to minimize the size of the drone and to ease its accommodation inside drone box.

In other example embodiments, packages stored in portable drone cargo compartments are processed and accommodated inside drone nest station compartment. Packages delivering and loading or unloading may be in this case provided by ejected drone box platform, as illustrated on FIG. 5. As user packages will be stored inside standardized package boxes and inside portable drone cargo compartment, still similar level of package protection may be guaranteed. The main difference is that drones may not be stored inside drone nest station compartments.

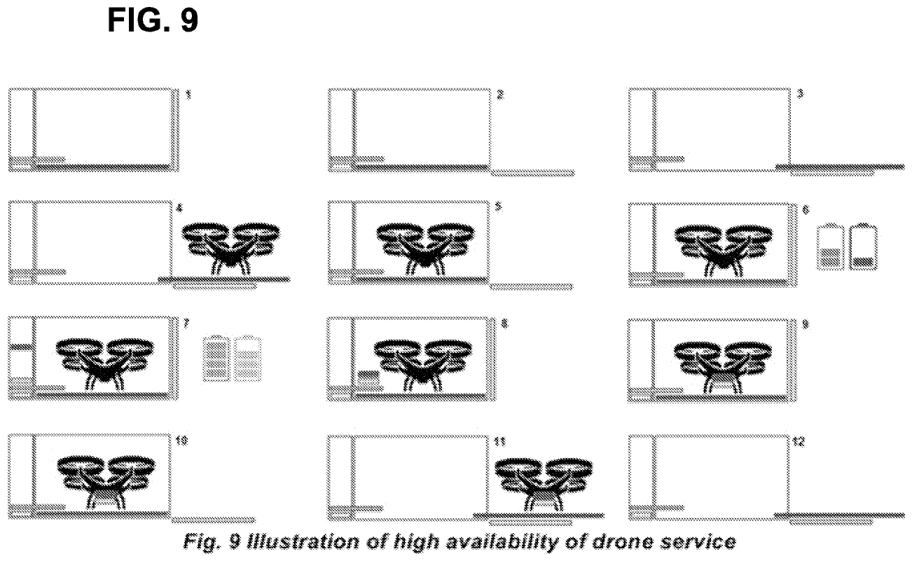

FIG. 9 illustrates an example of high availability of drone service, in accordance with an example embodiment of the invention. The functions of the package loading process are controlled by a program stored in the memory 110 and executed by the CPU 108 of the drone nest station. In the example package loading process, the drone is accommodated inside drone box. At (1), the given drone box is empty. When the control unit of the drone nest station receives a request to handle a drone, a drone box door is opened (2) and a moving platform (3) is ejected. A drone is shown landing on the moving platform (4). After landing, a drone may be secured, and its power may be turned off. Drone may also minimize its size by folding up rotating parts, if necessary. A platform is returning with the drone on it, to the inside of the box (5). A box door is closed (6). Once inside, the drone's batteries may be recharged, as most likely the drone's power may be on minimal level. If the drone carried cargo in the drone cargo compartment, the packages may be unloaded, or the entire drone cargo compartment may be unmounted, if a portable version is used. A moving platform may also act as a charging platform when induction is used for battery charging. Other wire and wireless options may be also applied. When a charging process is completed, after a typical period of 15 to 90 minutes, or if the drone's power level is enough for a flight route on a specified distance, the packages of the cargo load may be loaded by the embarking unit, as shown on (7). When all packages for this specified part of the route are delivered, packages are delivered to the drone (8) and mounted on it (9). This process may be monitored by a nest control and monitoring program stored in the memory 110 and executed by the CPU 108 of the drone nest station. Next, when drone is ready, the box door is opened again (10), drone with cargo is shown moving outside (11) and when positioned in place, a drone may be released (12).

A drone box may stay in (12) state (FIG. 9), waiting for another drone approaching this drone nest, or it may close the door, sequence (3, 2, 1). Packages may be delivered to the given drone's nest airborne by any drones, or from the ground (FIG. 5). The requirements are to use standardized package boxes.

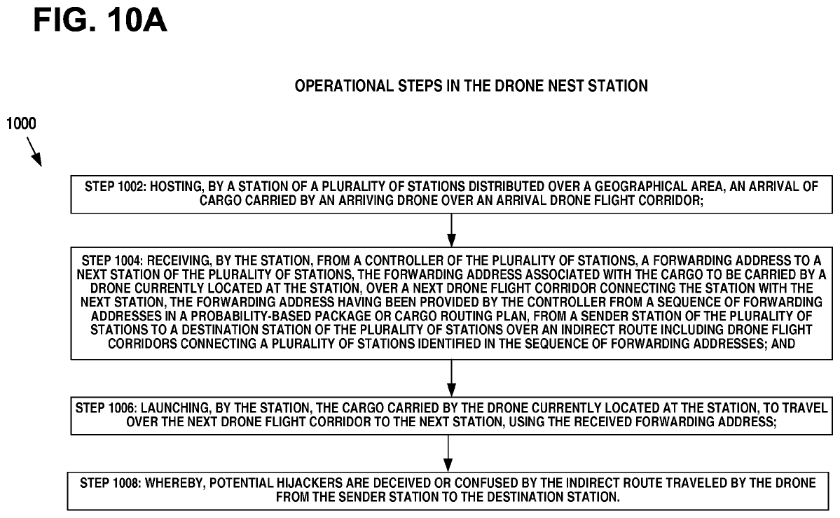

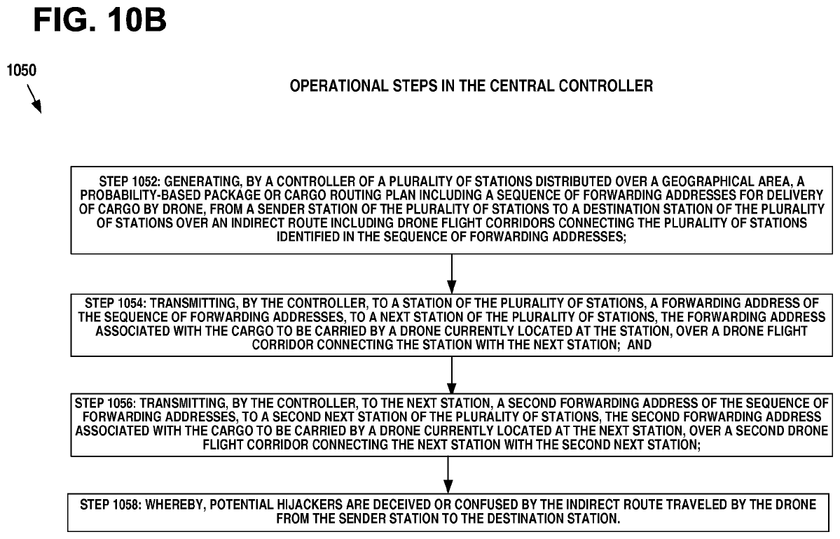

FIG. 10A illustrates an example flow diagram 1000 of operational steps in a drone nest station 102A to 102H for the secure delivery of cargo by drones, in accordance with at least one embodiment of the present invention. The steps of the flow diagram represent computer code instructions stored in the device's RAM and/or ROM memory 110, which when executed by the device's central processing units 108, carry out the functions of the example embodiments of the invention. The steps may be carried out in another order than shown and individual steps may be combined or separated into component steps. In some embodiments, one or more steps may be optional. The flow diagram has the following steps:

Step 1002: hosting, by a station of a plurality of stations distributed over a geographical area, an arrival of cargo carried by an arriving drone over an arrival drone flight corridor;

Step 1004: receiving, by the station, from a controller of the plurality of stations, a forwarding address to a next station of the plurality of stations, the forwarding address associated with the cargo to be carried by a drone currently located at the station, over a next drone flight corridor connecting the station with the next station, the forwarding address having been provided by the controller from a sequence of forwarding addresses in a probability-based package or cargo routing plan, from a sender station of the plurality of stations to a destination station of the plurality of stations over an indirect route including drone flight corridors connecting a plurality of stations identified in the sequence of forwarding addresses (in some embodiments an address may be provided directly on package box envelope); and

Step 1006: launching, by the station, the cargo carried by the drone currently located at the station, to travel over the next drone flight corridor to the next station, using the received forwarding address;

Step 1008: whereby, potential hijackers are deceived or confused by the indirect route traveled by the package or cargo from the sender station to the destination station.

In an example embodiment of the invention, another drone may be carrying a package/cargo over the next route. A drone has no information what will be the next assigned forwarding address of a package. The drone knows that some package or cargo needs to be carried to the next drone nest station. An address of the next station is a standardized address of the flight route assigned to this corridor. A drone is ordered to deliver something to the next point. Since the package weight/size is standardized and within allowed limits, the drone will be able to reach the next point in any weather or operational conditions.

FIG. 10B illustrates an example flow diagram 1050 of operational steps in the central controller 100 for the secure delivery of cargo by drones, in accordance with at least one embodiment of the present invention. The steps of the flow diagram represent computer code instructions stored in the device's RAM and/or ROM memory 106, which when executed by the device's central processing units 104, carry out the functions of the example embodiments of the invention. The steps may be carried out in another order than shown and individual steps may be combined or separated into component steps. In some embodiments, one or more steps may be optional. The flow diagram has the following steps:

Step 1052: generating, by a controller of a plurality of stations distributed over a geographical area, a probability-based package or cargo routing plan including a sequence of forwarding addresses for delivery of cargo by drone, from a sender station of the plurality of stations to a destination station of the plurality of stations over an indirect route including drone flight corridors connecting the plurality of stations identified in the sequence of forwarding addresses;

Step 1054: transmitting, by the controller, to a station of the plurality of stations, a forwarding address of the sequence of forwarding addresses, to a next station of the plurality of stations, the forwarding address associated with the cargo to be carried by a drone currently located at the station, over a drone flight corridor connecting the station with the next station; and

Step 1056: transmitting, by the controller, to the next station, a second forwarding address of the sequence of forwarding addresses, to a second next station of the plurality of stations, the second forwarding address associated with the cargo to be carried by a drone currently located at the next station, over a second drone flight corridor connecting the next station with the second next station (different drones operated over each corridor may deliver the same package/cargo);

Step 1058: whereby, potential hijackers are deceived or confused by the indirect route traveled by the package or cargo from the sender station to the destination station (different drones operated over each corridor may deliver the same package/cargo).

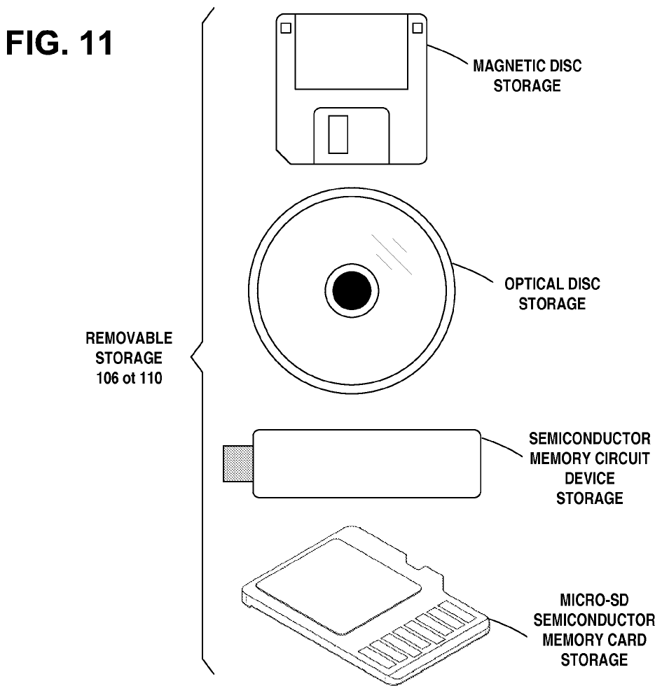

FIG. 11 illustrates an example embodiment of the invention, wherein examples of removable storage media 106 or 110 are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with an example embodiment of the invention.

Although specific example embodiments have been disclosed, a person skilled in the art will understand that changes can be made to the specific example embodiments without departing from the spirit and scope of the invention.

1-27. (canceled)

28. An apparatus for delivery of cargo, comprising:
at least one processor;
at least one memory including computer program code;
the at least one memory and the computer program code configured to, with the at least one processor, cause the apparatus at least to:
receive, by a station of one or more stations distributed over a geographical area, from one or more controllers of the one or more stations, at least one forwarding address from one or more forwarding addresses to one or more stations of the one or more stations,
the at least one forwarding address associated with cargo carried by an arriving vehicle over an arrival vehicle route, wherein the at least one forwarding address is caused to instruct a departing vehicle located at the station to travel to a next station of the one or more stations,
the at least one forwarding address having been provided by the one or more controllers from the one or more forwarding addresses in a probability-based package or cargo routing plan, from a sender station of the one or more stations to a destination station of the one or more stations over a route including the one or more stations identified in the one or more forwarding addresses; and
cause launching, by the station, the cargo carried by the departing vehicle to travel to the next station over a departing vehicle route, using the received at least one forwarding address.

29. The apparatus of claim 28, further comprising:
the at least one memory and the computer program code configured to, with the at least one processor, cause the apparatus at least to:
determine, by the station, whether conditions have changed for traveling from the station to the next station; and
modify, by the station, the received at least one forwarding address into a second forwarding address of another station of the one or more stations, if conditions are determined to have changed for traveling from the station to the next station.

30. The apparatus of claim 28, wherein the route including the one or more stations identified in the one or more forwarding addresses is an indirect route that provides a level of security for delivery of the cargo from the sender station of the one or more stations to the destination station of the one or more stations.

31. The apparatus of claim 28, wherein the departing vehicle located at the station is different from the arriving vehicle.

32. The apparatus of claim 28, wherein the cargo is one or more packages carried by each of a plurality of vehicles in different respective segments of the route.

33. The apparatus of claim 30, wherein the vehicle includes a cargo compartment to provide protection against unauthorized access to the cargo and the cargo can wait for transportation over a next segment of the indirect route, and wherein the cargo is unloaded by the vehicle on arrival at the station and the cargo is reloaded onto another vehicle that carries the cargo to the next station.

34. The apparatus of claim 28, wherein the probability-based package or cargo routing plan includes at least one of user requirements for specified levels of security, with higher levels of security being provided by additional route segments of the indirect route, the probability-based package or cargo routing plan includes user requirements for specified delivery time, specifying when a cargo is to be delivered to the destination station, the probability-based package or cargo routing plan includes fake vehicle delivery, or the probability-based package or cargo routing plan includes purposeful delays of delivered cargo or packages inside stations.

35. The apparatus of claim 28 further comprising a first plan including a first sequence of planned forwarding addresses over a first indirect route from the sender station to the destination station having a first level of security and a second plan including a second sequence of planned forwarding addresses over a second indirect route from the sender station to the destination station having a second level of security.

36. The apparatus of claim 28, wherein the arriving and/or the departing vehicles are one or more autonomous, unmanned aerial vehicles (UAV) or drones.

37. An apparatus for delivery of cargo, comprising:
at least one processor;
at least one memory including computer program code;
the at least one memory and the computer program code configured to, with the at least one processor, cause the apparatus at least to:
generate, by a controller of one or more stations distributed over a geographical area, a probability-based package or cargo routing plan including one or more forwarding addresses to one or more stations of the one or more stations, for delivery of package or cargo from a sender station of the one or more stations to a destination station of the one of more stations over a route including the one or more stations identified in the one or more forwarding addresses; and
transmit, by the controller, to a station of the one or more stations, at least one forwarding address from the one or more forwarding addresses, the at least one forwarding address associated with cargo carried by an arriving vehicle at the station over an arrival vehicle route, the at least one forwarding address caused to instruct a departing vehicle located at the station to travel to a next station of the one or more stations.

38. The apparatus of claim 37, wherein the route including the one or more stations identified in the one or more forwarding addresses is an indirect route that provides a level of security for delivery of the package or cargo from the sender station of the one or more stations to the destination station of the one or more stations.

39. The apparatus of claim 37, further comprising:
the at least one memory and the computer program code configured to, with the at least one processor, cause the apparatus at least to:
generate, by the controller, a first probability-based package or cargo routing plan for a first level of security, the first plan including a first sequence of planned forwarding addresses for delivery of the package or cargo to a first sequence of the one or more stations from the sender station to the destination station;
generate, by the controller, a first forecast blockchain record for each of the one or more stations in the first sequence, each first forecast blockchain record contents including at least a planned next forwarding address of a next station in the first sequence of the one or more stations and information related to alternate next stations of the one or more stations, the controller computing a cryptographic hash value on a combination of a previous forecast blockchain record computed for a previous station of the one or more stations in the first sequence and the contents of the first forecast blockchain record;
generate, by the controller, a second probability-based package or cargo routing plan for a second level of security, the second plan including a second sequence of planned forwarding addresses for delivery of cargo to a second sequence of the one or more stations from the sender station to the destination station;
generate, by the controller, a second forecast blockchain record for each of the one or more stations in the second sequence, each second forecast blockchain record contents including at least a planned next forwarding address of a next station in the second sequence of the one or more stations and information related to alternate next stations of the one or more stations, the controller computing a cryptographic hash value on a combination of a previous forecast blockchain record computed for a previous station of the one or more stations in the second sequence and the contents of the second forecast blockchain record; and
select, by the controller, either the first probability-based package or cargo routing plan for the first level of security or the second probability-based package or cargo routing plan for the second level of security, based on a required level of security for delivery of the package or cargo.

40. An apparatus for delivery of package or cargo, comprising:
at least one processor;
at least one memory including computer program code;
the at least one memory and the computer program code configured to, with the at least one processor, cause the apparatus at least to:
plan routes between different destinations and stations for secure package or cargo delivery, including alternative subroutes between the stations;
measure probabilities for traversing the different routes and alternative subroutes between the different stations for secure delivery of package or cargo, and
select one or more of the different routes or alternative subroutes whose measured probability provides a required level of security for delivery of package or cargo.

41. The apparatus of claim 40, further comprising:
the at least one memory and the computer program code configured to, with the at least one processor, cause the apparatus at least to:
select one or more alternative vehicles for the delivery of package or cargo to be used in the one or more selected different routes or alternative subroutes.

42. The apparatus of claim 40, further comprising:
the at least one memory and the computer program code configured to, with the at least one processor, cause the apparatus at least to:
determine availability of one or more vehicles on one or more of the different routes or alternative subroutes for the delivery of package or cargo.
